(19) United States
(12) Patent Application Publication
(10) Pub. No.: US 2016/0139363 A1
(43) Pub. Date: May 19, 2016

(54) MOBILE DEVICE AND OPTICAL IMAGING LENS THEREOF

(71) Applicant: GeniuS Electronic Optical Co., Ltd., Taichung City (TW)

(72) Inventors: Sheng Wei Hsu, Taichung City (TW); Tzu-Chien Tang, Taichung City (TW)

(21) Appl. No.: 14/660,749

(22) Filed: Mar. 17, 2015

(30) Foreign Application Priority Data
Nov. 19, 2014 (TW) 103140091

(51) Int. Cl. G02B 13/00; H04N 5/225; G02B 9/34

(52) U.S. Cl. CPC G02B 13/0015; G02B 9/34; H04N 5/2254; H04N 5/2253; H04N 5/2252

(57) ABSTRACT

Present embodiments provide for a mobile device and an optical imaging lens thereof. The optical imaging lens may comprise four lens elements positioned sequentially from an object side to an image side. Through controlling the convex or concave shape of the surfaces of the lens elements and designing parameters satisfying at least one inequality, the optical imaging lens may exhibit better optical characteristics and the total length of the optical imaging lens may be shortened.

### INCORPORATION BY REFERENCE

This application claims priority from Taiwan Patent Application No. 103140091, filed on Nov. 19, 2014, the contents of which are hereby incorporated by reference in their entirety for all purposes.

### TECHNICAL FIELD

The present disclosure relates to a mobile device and an optical imaging lens thereof, and particularly, relates to a mobile device applying an optical imaging lens having four lens elements and an optical imaging lens thereof.

### BACKGROUND

The ever-increasing demand for smaller sized mobile devices, such as cell phones, digital cameras, etc. correspondingly triggered a growing need for a smaller sized photography module, comprising elements such as an optical imaging lens, a module housing unit, and an image sensor, etc., contained therein. Size reductions may be contributed from various aspects of the mobile devices, which includes not only the charge coupled device (CCD) and the complementary metal-oxide semiconductor (CMOS), but also the optical imaging lens mounted therein. When reducing the size of the optical imaging lens, however, achieving good optical characteristics becomes a challenging problem. Such as the optical imaging lenses in U.S. Pat. Nos. 7,848,032, 8,284,502 and 8,179,616, all of which disclosed an optical imaging lens constructed with an optical imaging lens having four lens elements, the length of the optical imaging lens, from the object-side surface of the first lens element to the image plane, exceeds 8 mm, wherein the length of the optical imaging lens disclosed in U.S. Pat. No. 8,179,616 exceeds 11 mm. These optical imaging lenses are too long for smaller sized mobile devices.

Therefore, there is a need for improved optical imaging lens which may have the capability to house four lens elements therein, with a shorter length, while also having good optical characteristics and broadening field angles.

### SUMMARY

According to some embodiments, the present disclosure may provide for a mobile device and an optical imaging lens thereof. With controlling the convex or concave shape of the surfaces, the length of the optical imaging lens may be shortened while maintaining desirable optical characteristics.

In some embodiments, an optical imaging lens may comprise, sequentially from an object side to an image side along an optical axis, an aperture stop, a first lens element, a second lens element, a third lens element, and a fourth lens element, each of the first, second, third and fourth lens elements having refracting power, an object-side surface facing toward the object side and an image-side surface facing toward the image side and a central thickness defined along the optical axis.

In the specification, parameters used here are: the central thickness of the first lens element, represented by T1, an air gap between the first lens element and the second lens element along the optical axis, represented by G12, the central thickness of the second lens element, represented by T2, an air gap between the second lens element and the third lens element along the optical axis, represented by G23, the central thickness of the third lens element, represented by T3, an air gap between the third lens element and the fourth lens element along the optical axis, represented by G34, the central thickness of the fourth lens element, represented by T4, a distance between the image-side surface of the fourth lens element and the object-side surface of a filtering unit along the optical axis, represented by G4F, the central thickness of the filtering unit along the optical axis, represented by TF, a distance between the image-side surface of the filtering unit and an image plane along the optical axis, represented by GFP, a focusing length of the first lens element, represented by f1, a focusing length of the second lens element, represented by f2, a focusing length of the third lens element, represented by f3, a focusing length of the fourth lens element, represented by f4, the refracting index of the first lens element, represented by n1, the refracting index of the second lens element, represented by n2, the refracting index of the third lens element, represented by n3, the refracting index of the fourth lens element, represented by n4, an abbe number of the first lens element, represented by v1, an abbe number of the second lens element, represented by v2, an abbe number of the third lens element, represented by v3, an abbe number of the fourth lens element, represented by v4, an effective focal length of the optical imaging lens, represented by EFL, a distance between the object-side surface of the first lens element and an image plane along the optical axis, represented by TTL, a sum of the central thicknesses of all four lens elements, i.e. a sum of T1, T2, T3, and T4, represented by ALT, a sum of all three air gaps from the first lens element to the fourth lens element along the optical axis, i.e. a sum of G12, G23, and G34, represented by AAG, a back focal length of the optical imaging lens, which is defined as the distance from the image-side surface of the sixth lens element to the image plane along the optical axis, i.e. a sum of G4F, TF and GFP, and represented by BFL.

According to some embodiments of the present disclosure, for an optical imaging lens, the object-side surface of the first lens element may comprise a convex portion in a vicinity of a periphery of the first lens element; the second lens element may have negative refracting power; the object-side surface of the second lens element may comprise a concave portion in a vicinity of the optical axis and a concave portion in a vicinity of a periphery of the second lens element; the third lens element may have positive refracting power; the object-side surface of the third lens element may comprise a concave portion in a vicinity of the optical axis and a concave portion in a vicinity of a periphery of the third lens element; the image-side surface of the third lens element may comprise a convex portion in a vicinity of the optical axis and a convex portion in a vicinity of a periphery of the third lens element; the fourth lens element may be manufactured from plastic material; the object-side surface of the fourth lens element may comprise a convex portion in a vicinity of the optical axis; the image-side surface of the fourth lens element may comprise a convex portion in a vicinity of a periphery of the fourth lens element. In some embodiments, the optical imaging lens may comprise no other lenses having refracting power beyond the four lens elements. In some embodiments, the parameters described above may be controlled to satisfy three equations as follows:

T1/G12≦2.24 Equation(1);

ALT/G12≦8.3 Equation(2); and

ALT≦2.86 mm Equation(3).

Moreover, the parameters described above could be further controlled to satisfy these equations as follows:

ALT/AAG≦4.5 Equation(4);

T4/G23≦5.55 Equation(5);

EFL/G23≦30 Equation(6);

ALT/T4≦5.1 Equation(7);

AAG/G23≦6.5 Equation(8);

1.58≦T3/G12 Equation(9);

T3/T4≦2 Equation(10);

T1/G23≦6.77 Equation(11);

G12/G23≦5 Equation(12);

0.9≦AAG/T1 Equation(13);

0.7≦AAG/T3 Equation(14);

ALT/G23≦23.85 Equation(15);

T2/G23≦4.0 Equation(16);

3.5≦EFL/T3 Equation(17);

T2/G23≦2.5 Equation(18).

Features of the aforesaid embodiments are not limiting and may be selectively incorporated in other embodiments described herein. In some embodiments, more details about the convex or concave surface structure may be incorporated for one specific lens element or broadly for plural lens elements to enhance the control for the system performance and/or resolution. It is noted that the details listed here may be incorporated in example embodiments if no inconsistency occurs.

In other embodiments, a mobile device may comprise a housing and a photography module positioned in the housing. The photography module may comprise any of aforesaid example embodiments of optical imaging lens, a lens barrel, a module housing unit and an image sensor. The lens barrel may allow for positioning the optical imaging lens. The module housing unit may be used for positioning the lens barrel, and the image sensor may be positioned at the image side of the optical imaging lens.

Through controlling the convex or concave shape of the surfaces, the mobile device and the optical imaging lens thereof in some embodiments may achieve good optical characteristics and effectively shorten the length of the optical imaging lens.

### BRIEF DESCRIPTION OF THE DRAWINGS

Embodiments of the present disclosure will be more readily understood from the following detailed description when read in conjunction with the appended drawing, in which:

FIG. 1 is a cross-sectional view of one single lens element according to the present disclosure;

FIG. 2 is a schematic view of the relation between the surface shape and the optical focus of the lens element;

FIG. 3 is a schematic view of a first example of the surface shape and the efficient radius of the lens element;

FIG. 4 is a schematic view of a second example of the surface shape and the efficient radius of the lens element;

FIG. 5 is a schematic view of a third example of the surface shape and the efficient radius of the lens element;

FIG. 6 is a cross-sectional view of a first embodiment of an optical imaging lens having six lens elements according to the present disclosure;

FIG. 7 is a chart of longitudinal spherical aberration and other kinds of optical aberrations of a first embodiment of the optical imaging lens according to the present disclosure;

FIG. 8 is a table of optical data for each lens element of a first embodiment of an optical imaging lens according to the present disclosure;

FIG. 9 is a table of aspherical data of a first embodiment of the optical imaging lens according to the present disclosure;

FIG. 10 is a cross-sectional view of a second embodiment of an optical imaging lens having six lens elements according to the present disclosure;

FIG. 11 is a chart of longitudinal spherical aberration and other kinds of optical aberrations of a second embodiment of the optical imaging lens according to the present disclosure;

FIG. 12 is a table of optical data for each lens element of the optical imaging lens of a second embodiment of the present disclosure;

FIG. 13 is a table of aspherical data of a second embodiment of the optical imaging lens according to the present disclosure;

FIG. 14 is a cross-sectional view of a third embodiment of an optical imaging lens having six lens elements according to the present disclosure;

FIG. 15 is a chart of longitudinal spherical aberration and other kinds of optical aberrations of a third embodiment of the optical imaging lens according the present disclosure;

FIG. 16 is a table of optical data for each lens element of the optical imaging lens of a third embodiment of the present disclosure;

FIG. 17 is a table of aspherical data of a third embodiment of the optical imaging lens according to the present disclosure;

FIG. 18 is a cross-sectional view of a fourth embodiment of an optical imaging lens having six lens elements according to the present disclosure;

FIG. 19 is a chart of longitudinal spherical aberration and other kinds of optical aberrations of a fourth embodiment of the optical imaging lens according the present disclosure;

FIG. 20 is a table of optical data for each lens element of the optical imaging lens of a fourth embodiment of the present disclosure;

FIG. 21 is a table of aspherical data of a fourth embodiment of the optical imaging lens according to the present disclosure;

FIG. 22 is a cross-sectional view of a fifth embodiment of an optical imaging lens having six lens elements according to the present disclosure;

FIG. 23 is a chart of longitudinal spherical aberration and other kinds of optical aberrations of a fifth embodiment of the optical imaging lens according the present disclosure;

FIG. 24 is a table of optical data for each lens element of the optical imaging lens of a fifth embodiment of the present disclosure;

FIG. 25 is a table of aspherical data of a fifth embodiment of the optical imaging lens according to the present disclosure;

FIG. 26 is a cross-sectional view of a sixth embodiment of an optical imaging lens having six lens elements according to the present disclosure;

FIG. 27 is a chart of longitudinal spherical aberration and other kinds of optical aberrations of a sixth embodiment of the optical imaging lens according the present disclosure;

FIG. 28 is a table of optical data for each lens element of the optical imaging lens of a sixth embodiment of the present disclosure;

FIG. 29 is a table of aspherical data of a sixth embodiment of the optical imaging lens according to the present disclosure;

FIG. 30 is a cross-sectional view of a seventh embodiment of an optical imaging lens having six lens elements according to the present disclosure;

FIG. 31 is a chart of longitudinal spherical aberration and other kinds of optical aberrations of a seventh embodiment of the optical imaging lens according to the present disclosure;

FIG. 32 is a table of optical data for each lens element of a seventh embodiment of an optical imaging lens according to the present disclosure;

FIG. 33 is a table of aspherical data of a seventh embodiment of the optical imaging lens according to the present disclosure;

FIG. 34 is a cross-sectional view of a eighth embodiment of an optical imaging lens having six lens elements according to the present disclosure;

FIG. 35 is a chart of longitudinal spherical aberration and other kinds of optical aberrations of a eighth embodiment of the optical imaging lens according to the present disclosure;

FIG. 36 is a table of optical data for each lens element of the optical imaging lens of a eighth embodiment of the present disclosure;

FIG. 37 is a table of aspherical data of a eighth embodiment of the optical imaging lens according to the present disclosure;

FIG. 38 is a table for the values of T1/G12, ALT/G12, ALT, ALT/AAG, T4/G23, EFL/G23, ALT/T4, AAG/G23, T3/G12, T3/T4, T1/G23, G12/G23, AAG/T1, AAG/T3, ALT/G23, T2/G23 and EFL/T3 of all eight example embodiments;

FIG. 39 is a structure of an example embodiment of a mobile device;

FIG. 40 is a partially enlarged view of the structure of another example embodiment of a mobile device.

### DETAILED DESCRIPTION

For a more complete understanding of the present disclosure and its advantages, reference is now made to the following description taken in conjunction with the accompanying drawings, in which like reference numbers indicate like features. Persons having ordinary skill in the art will understand other varieties for implementing example embodiments, including those described herein. The drawings are not limited to specific scale and similar reference numbers are used for representing similar elements. As used in the disclosures and the appended claims, the terms “example embodiment,” “exemplary embodiment,” and “present embodiment” do not necessarily refer to a single embodiment, although it may, and various example embodiments may be readily combined and interchanged, without departing from the scope or spirit of the present disclosure. Furthermore, the terminology as used herein is for the purpose of describing example embodiments only and is not intended to be a limitation of the disclosure. In this respect, as used herein, the term “in” may include “in” and “on”, and the terms “a”, “an” and “the” may include singular and plural references. Furthermore, as used herein, the term “by” may also mean “from”, depending on the context. Furthermore, as used herein, the term “if” may also mean “when” or “upon”, depending on the context. Furthermore, as used herein, the words “and/or” may refer to and encompass any and all possible combinations of one or more of the associated listed items.

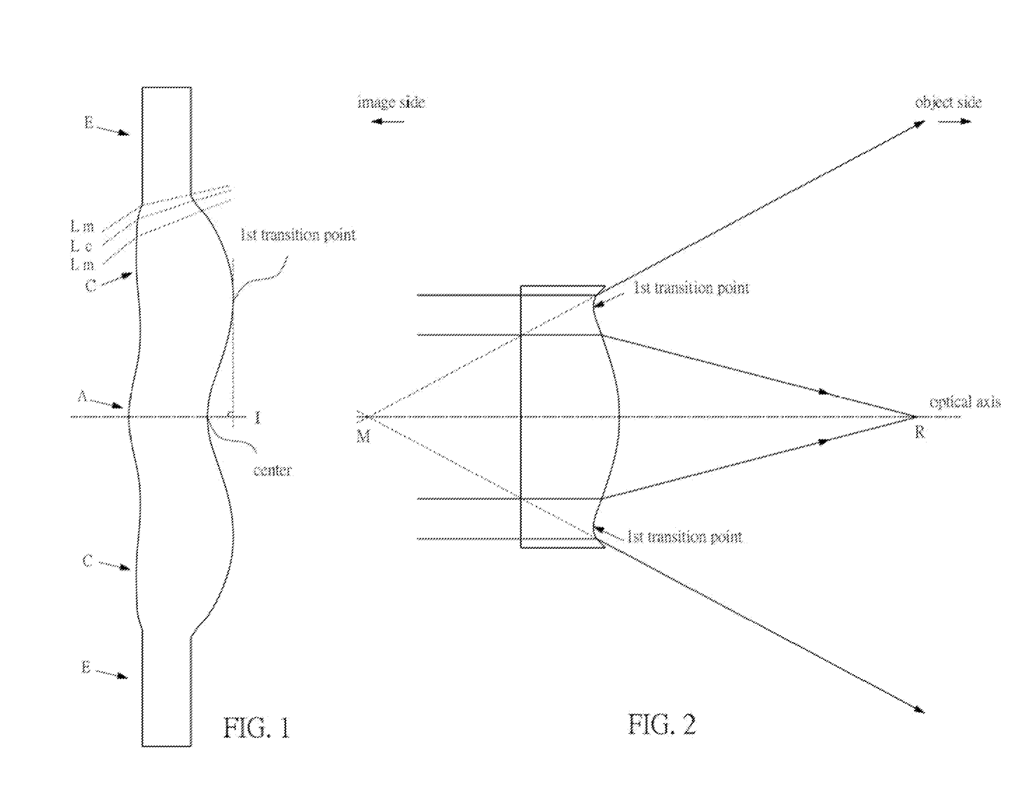

In the present disclosure, the description “a lens element having positive refracting power (or negative refracting power)” means that the paraxial refracting power of the lens element in Gaussian optics is positive (or negative). The description “An object-side (or image-side) surface of a lens element” only includes a specific region of that surface of the lens element where imaging rays are capable of passing through that region, namely the clear aperture of the surface. The aforementioned imaging rays can be classified into two types, chief ray Lc and marginal ray Lm. Taking a lens element depicted in FIG. 1 as an example, the lens element is rotationally symmetric, where the optical axis I is the axis of symmetry. The region A of the lens element is defined as “a portion in a vicinity of the optical axis”, and the region C of the lens element is defined as “a portion in a vicinity of a periphery of the lens element.” Besides, the lens element may also have an extending portion E extended radially and outwardly from the region C, namely the portion outside of the clear aperture of the lens element. The extending portion E is usually used for physically assembling the lens element into an optical imaging lens system. Under normal circumstances, the imaging rays would not pass through the extending portion E because those imaging rays only pass through the clear aperture. The structures and shapes of the aforementioned extending portion E are only examples for technical explanation, the structures and shapes of lens elements should not be limited to these examples. Note that the extending portions of the lens element surfaces depicted in the following embodiments are partially omitted.

The following criteria are provided for determining the shapes and the portions of lens element surfaces set forth in the present disclosure. These criteria mainly determine the boundaries of portions under various circumstances including the portion in a vicinity of the optical axis, the portion in a vicinity of a periphery of a lens element surface, and other types of lens element surfaces such as those having multiple portions.

FIG. 1 depicts a radial cross-sectional view of a lens element. Before determining boundaries of those aforesaid portions, two referential points should be defined first, central point and transition point. The central point of a surface of a lens element is a point of intersection of that surface and the optical axis. The transition point is a point on a surface of a lens element, where the tangent line of that point is perpendicular to the optical axis. Additionally, if multiple transition points appear on one single surface, then these transition points are sequentially named along the radial direction of the surface with numbers starting from the first transition point. For instance, the first transition point (closest one to the optical axis), the second transition point, and the Nth transition point (farthest one to the optical axis within the scope of the clear aperture of the surface). The portion of a surface of the lens element between the central point and the first transition point is defined as the portion in a vicinity of the optical axis. The portion located radially outside of the Nth transition point (but still within the scope of the clear aperture) is defined as the portion in a vicinity of a periphery of the lens element. In some embodiments, there may be other portions existing between the portion in a vicinity of the optical axis and the portion in a vicinity of a periphery of the lens element; the numbers of portions may depend on the numbers of the transition point(s). In addition, the radius of the clear aperture (or a so-called effective radius) of a surface may be defined as the radial distance from the optical axis I to a point of intersection of the marginal ray Lm and the surface of the lens element.

Referring to FIG. 2, determining the shape of a portion is convex or concave depends on whether a collimated ray passing through that portion converges or diverges. That is, while applying a collimated ray to a portion to be determined in terms of shape, the collimated ray passing through that portion will be bended and the ray itself or its extension line will eventually meet the optical axis. The shape of that portion may be determined by whether the ray or its extension line meets (intersects) the optical axis (focal point) at the object-side or image-side. For instance, if the ray itself intersects the optical axis at the image side of the lens element after passing through a portion, i.e. the focal point of this ray is at the image side (see point R in FIG. 2), the portion may be determined as having a convex shape. In contrast, if the ray diverges after passing through a portion, the extension line of the ray intersects the optical axis at the object side of the lens element, i.e. the focal point of the ray is at the object side (see point M in FIG. 2), that portion may be determined as having a concave shape. Therefore, referring to FIG. 2, the portion between the central point and the first transition point may have a convex shape; the portion located radially outside of the first transition point may have a concave shape. Further, the first transition point is the point where the portion having a convex shape changes to the portion having a concave shape, namely the border of two adjacent portions. Alternatively, there may be another common way for a person with ordinary skill in the art to tell whether a portion in a vicinity of the optical axis has a convex or concave shape by referring to the sign of an “R” value, which is the (paraxial) radius of curvature of a lens surface. The R value which is commonly used in conventional optical design software such as Zemax and CodeV. The R value usually appears in the lens data sheet in the software. For an object-side surface, positive R means that the object-side surface is convex, and negative R means that the object-side surface is concave. Conversely, for an image-side surface, positive R means that the image-side surface is concave, and negative R means that the image-side surface is convex. The result found by using this method should be consistent as by using the other way mentioned above, which determines surface shapes by referring to whether the focal point of a collimated ray is at the object side or the image side.

For none transition point cases, the portion in a vicinity of the optical axis is defined as the portion between 0˜50% of the effective radius (radius of the clear aperture) of the surface, whereas the portion in a vicinity of a periphery of the lens element is defined as the portion between 50˜100% of effective radius (radius of the clear aperture) of the surface.

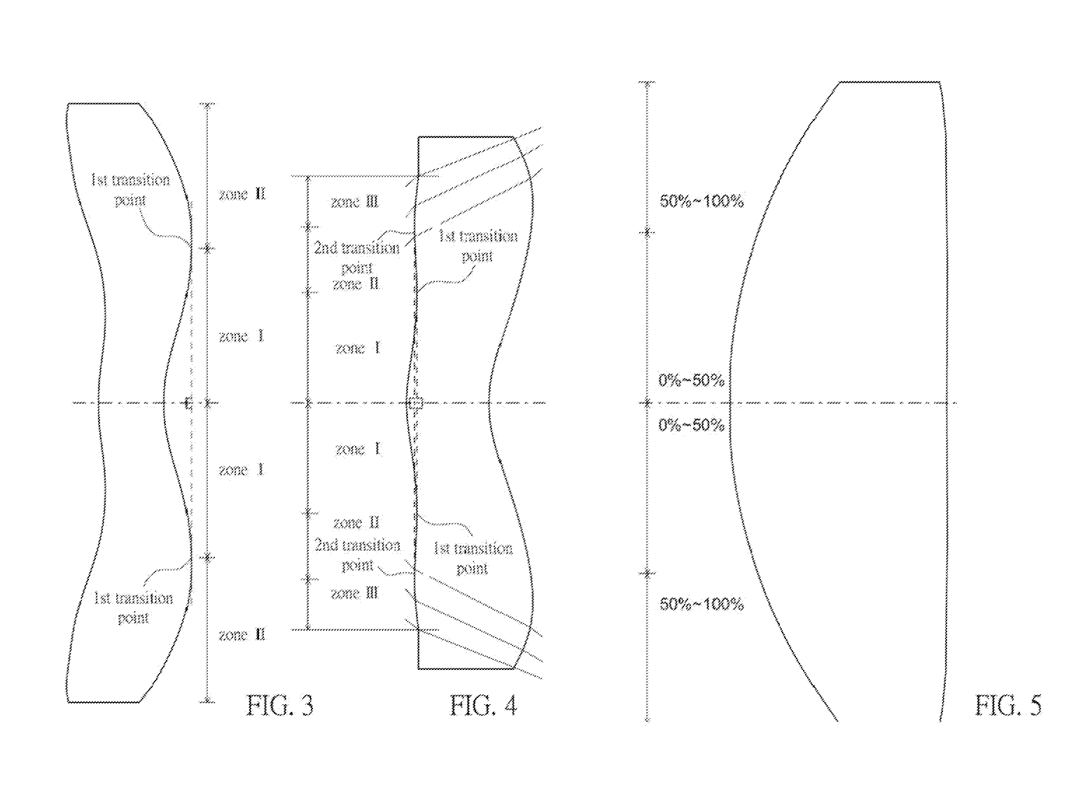

Referring to the first example depicted in FIG. 3, only one transition point, namely a first transition point, may appear within the clear aperture of the image-side surface of the lens element. Portion I may be a portion in a vicinity of the optical axis, and portion II may be a portion in a vicinity of a periphery of the lens element. The portion in a vicinity of the optical axis may be determined as having a concave surface due to the R value at the image-side surface of the lens element is positive. The shape of the portion in a vicinity of a periphery of the lens element may be different from that of the radially inner adjacent portion, i.e. the shape of the portion in a vicinity of a periphery of the lens element is different from the shape of the portion in a vicinity of the optical axis; the portion in a vicinity of a periphery of the lens element has a convex shape.

Referring to the second example depicted in FIG. 4, a first transition point and a second transition point may exist on the object-side surface (within the clear aperture) of a lens element. Here, portion I may be the portion in a vicinity of the optical axis, and portion III may be the portion in a vicinity of a periphery of the lens element. The portion in a vicinity of the optical axis may have a convex shape because the R value at the object-side surface of the lens element is positive. The portion in a vicinity of a periphery of the lens element (portion III) has a convex shape. Further, there may be another portion having a concave shape existing between the first and second transition point (portion II).

Referring to a third example depicted in FIG. 5, no transition point exists on the object-side surface of the lens element. In this case, the portion between 0˜50% of the effective radius (radius of the clear aperture) is determined as the portion in a vicinity of the optical axis, and the portion between 50˜100% of the effective radius is determined as the portion in a vicinity of a periphery of the lens element. The portion in a vicinity of the optical axis of the object-side surface of the lens element is determined as having a convex shape due to its positive R value, and the portion in a vicinity of a periphery of the lens element is determined as having a convex shape as well.

The optical imaging lens of the present disclosure may be a prime lens. The optical imaging lens may comprise a first lens element, a second lens element, a third lens element, and a fourth lens element, and these lens elements may be arranged sequentially from the object side to the image side along an optical axis. Each of the lens elements may comprise refracting power, an object-side surface facing toward an object side, and an image-side surface facing toward an image side. The optical imaging lens may comprise no other lenses having refracting power beyond the four lens elements. The design of the detail characteristics of each lens element can provide the short length and the improved imaging quality of optical imaging lens.

The optical imaging lens may further comprise an aperture stop, and the aperture stop may be in front of the first lens element such that the length of the optical imaging lens can be shortened.

The image-side surface of the first lens element may comprise a convex portion in a vicinity of a periphery of the first lens element; the second lens element may have negative refracting power, the object-side surface of the second lens element may comprise a concave portion in a vicinity of the optical axis and a concave portion in a vicinity of a periphery of the second lens element. The third lens element may have a positive refracting power. The object-side surface of the third lens element may comprise a concave portion in a vicinity of the optical axis and a concave portion in a vicinity of periphery of the third lens element. The image-side surface of the third lens element may comprise a convex portion in a vicinity of the optical axis and a convex portion in a vicinity of a periphery of the third lens element. The object-side surface of the fourth lens element may comprise a convex portion in a vicinity of the optical axis. The image-side surface of the fourth lens element may comprise a convex portion in a vicinity of a periphery of the fourth lens element. In some embodiments, the arrangement of these lens element described above may correct the optical aberration.

The fourth lens element may be manufactured from plastic materials. As a result, the cost of the optical imaging lens may be reduced and the weight of the lens element may be lightened. If the object-side surface of the first lens element further comprises a convex portion in a vicinity of the optical axis and a convex portion in a vicinity of a periphery of the first lens element; and the image-side surface of the fourth lens element further comprises a concave portion in a vicinity of the optical axis, the imaging quality of the optical imaging lens may be maintained during the process of shortening the length of the optical imaging lens. When all of the lens element are manufactured from plastic materials, it may be beneficial to manufacture the aspherical surface, reduce the cost, and lighten the weight of the optical imaging lens.

Because consumers request the imaging quality of the optical imaging lens more strictly and need the optical imaging lens having shorter length, the convex or concave shape of the surfaces in a vicinity of the optical axis and the convex or concave shape of the surfaces in a vicinity of the periphery of lens element may often be changed according to the light path. Further, the center region and the marginal region of the lens element may have different thicknesses. According to the characteristics of ray, the more marginal ray may need to pass through a longer path to focus to an image plane with the incident light in a vicinity of the optical axis. In the present disclosure, the image-side surface of the first lens element may comprise a convex portion in a vicinity of a periphery of the first lens element. The object-side surface of the second lens element may comprise a concave portion in a vicinity of the optical axis and a concave portion in a vicinity of a periphery of the second lens element. In such manner, the second lens element may not interface with the first lens element, and the size of G12 may be smaller to shorten than the total length of the optical imaging lens. But considering the height of the region of the second lens element which the ray incident on and the good imaging quality of optical imaging lens, G12 should be kept within a certain width. G12 must satisfies T1/G12≦2.24 and ALT/G12≦8.3.

Moreover, the value of G12 may need to be restricted to prevent the length of the lens from being too long. G12 may need to satisfy 1.58≦T3/G12, and the arrangements of T1, T3, ALT, G12 may be improved.

ALT presents the sum of the central thicknesses of the four lens elements. ALT get a big percentage of the total length of the optical imaging lens. If ALT can be decreased as soon as possible, it may be beneficial to shorten the total length of the optical imaging lens to satisfy ALT≦2.86 mm, ALT/AAG≦4.5, ALT/T4≦5.1 and ALT/G23≦23.85.

The object-side surface of the third lens element may comprise a concave portion in a vicinity of the optical axis and a concave portion in a vicinity of a periphery of the third lens element, and the third lens element may have positive refracting power. Considering the position of incident light relative to the third lens element and good imaging quality, the range of shortening G23 may be smaller to satisfy T4/G23≦5.55, EFL/G23≦30, AAG/G23≦6.5, T1/G23≦6.77, G12/G23≦5, and T2/G23≦4. T2 and G23 further satisfy T2/G23≦2.5, when T2/G23≦2.5, G23 may be bigger to benefit the assembly of the optical imaging lens and enhance the manufacture yield.

The third lens element may be concave-convex lens, so the thinness of third lens element may be smaller to shorten the optical imaging lens, and satisfy T3/T4≦2, 0.7≦AAG/T3, and 3.5≦EFL/T3.

G12 and G23 should be a suitable value to maintain a good imaging quality, so the range of shortening AAG may be smaller to satisfy 0.9≦AAG/T1, and the arrangement of T1 and AAG can be better.

T2/G12 may be between 1.0˜2.24, ALT/G12 may be between 5˜8.3, ALT may be between 1˜2.86 mm, ALT/AAG may be between 2.2˜4.5, T4/G23 may between 1.2˜5.55, EFL/G23 may be between 9˜30, ALT/T4 may be between 2.5˜5.1, AAG/G23 may be between 1.8˜6.5, T3/G12 may be between 1.58˜3.2, T3/T4 may be between 0.3˜2, T1/G23 may be between 1.5˜6.77, G12/G23 may be between 0.5˜5, AAG/T1 may be between 0.9˜1.8, AAG/T3 may be between 0.7˜1.6, ALT/G23 may be between 7˜23.85, T2/G23 may be between 0.3˜4, and EFL/T3 may be between 3.5˜5.2.

When implementing example embodiments, more details about the convex or concave surface could be incorporated for one specific lens element or broadly for plural lens elements to enhance the control for the system performance and/or resolution. It is noted that the details listed here could be incorporated in example embodiments if no inconsistency occurs.

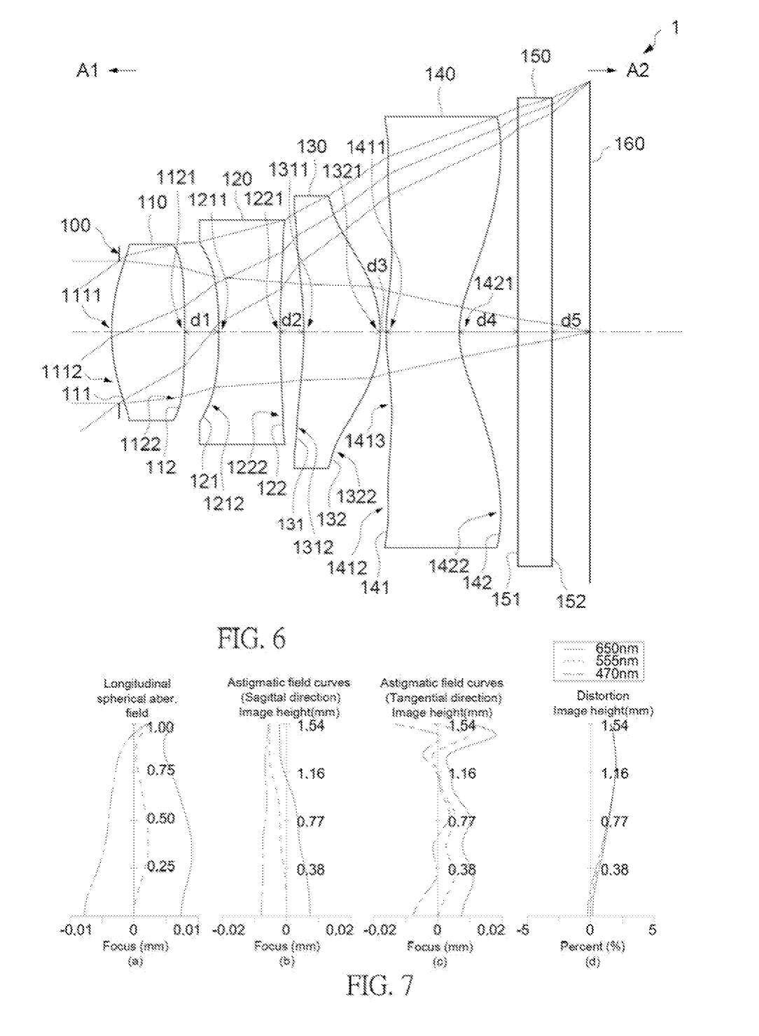

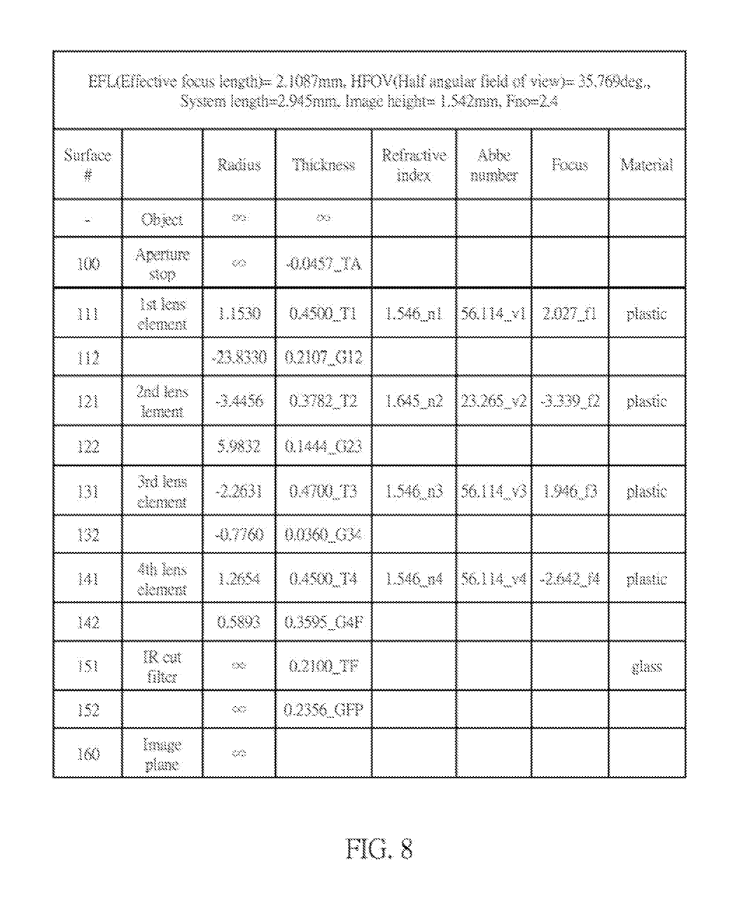

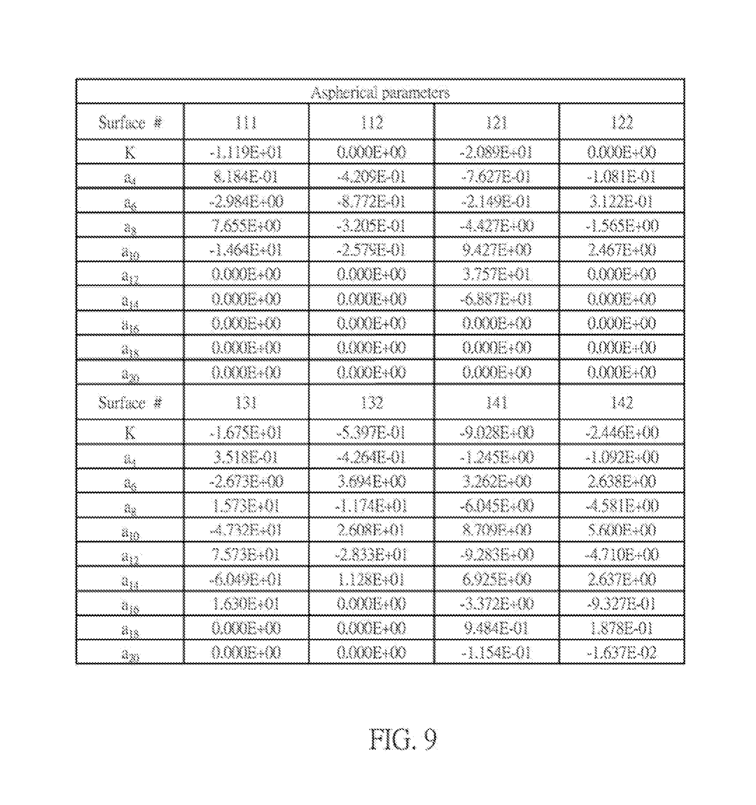

Several exemplary embodiments and associated optical data will now be provided for illustrating example embodiments of optical imaging lens with good optical characteristics and a shortened length. Reference is now made to FIGS. 6-9. FIG. 6 illustrates an example cross-sectional view of an optical imaging lens 1 having four lens elements of the optical imaging lens according to a first example embodiment. FIG. 7 shows example charts of longitudinal spherical aberration and other kinds of optical aberrations of the optical imaging lens 1 according to an example embodiment. FIG. 8 illustrates an example table of optical data of each lens element of the optical imaging lens 1 according to an example embodiment, in which f is used for representing EFL. FIG. 9 depicts an example table of aspherical data of the optical imaging lens 1 according to an example embodiment.

As shown in FIG. 6, the optical imaging lens 1 of the present embodiment may comprise, in order from an object side A1 to an image side A2 along an optical axis, an aperture stop 100, a first lens element 110, a second lens element 120, a third lens element 130, and a fourth lens element 140. A filtering unit 150 and an image plane 160 of an image sensor may be positioned at the image side A2 of the optical lens 1. Each of the first, second, third, fourth lens elements 110, 120, 130, 140 and the filtering unit 150 may comprise an object-side surface 111/121/131/141/151 facing toward the object side A1 and an image-side surface 112/122/132/142/152 facing toward the image side A2. The example embodiment of the filtering unit 150 illustrated is an IR cut filter (infrared cut filter) positioned between the fourth lens element 140 and an image plane 160. The filtering unit 150 may selectively absorb light with specific wavelength from the light passing optical imaging lens 1. For example, IR light may be absorbed, and this may prohibit the IR light, which is not seen by human eyes, from producing an image on the image plane 160.

Please noted that during the normal operation of the optical imaging lens 1, the distance between any two adjacent lens elements of the first, second, third, and fourth lens elements 110, 120, 130, 140 may be an unchanged value, i.e. the optical imaging lens 1 is a prime lens.

Embodiments of each lens element of the optical imaging lens 1 which may be constructed by plastic material will now be described with reference to the drawings.

An example embodiment of the first lens element 110 may have positive refracting power. The object-side surface 111 may be a convex surface comprising a convex portion 1111 in a vicinity of the optical axis and a convex portion 1112 in a vicinity of a periphery of the first lens element 110. The image-side surface 112 may be a convex surface comprising a convex portion 1121 in a vicinity of the optical axis and a convex portion 1122 in a vicinity of the periphery of the first lens element 110. The object-side surface 111 and the image-side surface 112 may be aspherical surfaces.

An example embodiment of the second lens element 120 may have a negative refracting power. The object-side surface 121 may be a concave surface comprising a concave portion 1211 in a vicinity of the optical axis and a concave portion 1212 in a vicinity of a periphery of the second lens element 120. The image-side surface 122 may be a concave surface comprising a concave portion 1221 in a vicinity of the optical axis and a concave portion 1222 in a vicinity of the periphery of the second lens element 120.

An example embodiment of the third lens element 130 may have positive refracting power. The object-side surface 131 may be a concave surface comprising a concave portion 1311 in a vicinity of the optical axis and concave portion 1312 in a vicinity of a periphery of the third lens element 130. The image-side surface 132 may be a convex surface comprising a convex portion 1321 in a vicinity of the optical axis and a convex portion 1322 in a vicinity of the periphery of the third lens element 130. The object-side surface 131 and the image-side surface 132 may be aspherical surfaces.

An example embodiment of the fourth lens element 140 may have negative refracting power. The object-side surface 141 may comprise a convex portion 1411 in a vicinity of the optical axis, a convex portion 1412 in a vicinity of a periphery of the fourth lens element 140, and a concave portion 1413 between the convex portion 1411 and the convex portion 1412. The image-side surface 142 may comprise a concave portion 1421 in a vicinity of the optical axis and a convex portion 1422 in a vicinity of the periphery of the fourth lens element 140. The object-side surface 141 and the image-side surface 142 may be aspherical surfaces.

In some embodiments, air gaps may exist between the lens elements 110, 120, 130, 140, the filtering unit 150 and the image plane 160 of the image sensor. For example, FIG. 1 illustrates the air gap d1 existing between the first lens element 110 and the second lens element 120, the air gap d2 existing between the second lens element 120 and the third lens element 130, the air gap d3 existing between the third lens element 130 and the fourth lens element 140, the air gap d4 existing between the fourth lens element 140 and the filtering unit 150, the air gap d5 existing between the filtering unit 150 and the image plane 160 of the image sensor. However, in other embodiments, any of the aforesaid air gaps may or may not exist. For example, the profiles of opposite surfaces of any two adjacent lens elements may correspond to each other, and in such situation, the air gap may not exist. The air gap d1 is denoted by G12, the air gap d2 is denoted by G23, the air gap d3 is denoted by G34, and the sum of d1, d2, and d3 is denoted by AAG.

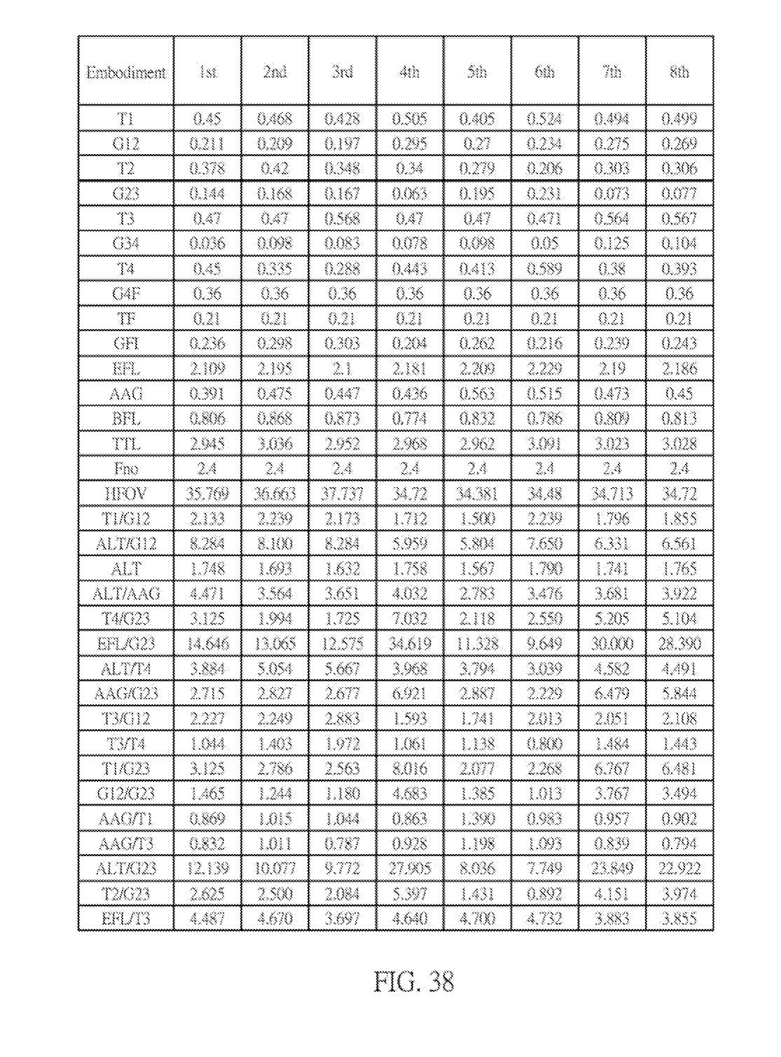

FIG. 8 depicts the optical characteristics of each lens elements in the optical imaging lens 1 of the present embodiment, and please refer to FIG. 38 for the values of T1/G12, ALT/G12, ALT, ALT/AAG, T4/G23, EFL/G23, ALT/T4, AAG/G23, T3/G12, T3/T4, T1/G23, G12/G23, AAG/T1, AAG/T3, ALT/G23, T2/G23, and EFL/T3 of the present embodiment.

The distance from the object-side surface 111 of the first lens element 110 to the image plane 160 along the optical axis is 2.945 mm, the image height may be 1.542 mm. The length of the optical imaging lens 1 may be shortened compared with conventional optical imaging lenses.

The aspherical surfaces including the object-side surface 111 of the first lens element 110, the image-side surface 112 of the first lens element 110, the object-side surface 121 and the image-side surface 122 of the second lens element 120, the object-side surface 131 and the image-side surface 132 of the third lens element 130, the object-side surface 141 and the image-side surface 142 of the fourth lens element 140 may all be defined by the following aspherical formula:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {Y}^{2 i}$$

wherein,

R represents the radius of curvature of the surface of the lens element;

Z represents the depth of the aspherical surface (the perpendicular distance between the point of the aspherical surface at a distance Y from the optical axis and the tangent plane of the vertex on the optical axis of the aspherical surface);

Y represents the perpendicular distance between the point of the aspherical surface and the optical axis;

K represents a conic constant;

a₂ᵢ represents an aspherical coefficient of 2i^{th} level.

The values of each aspherical parameter are shown in FIG. 9.

FIG. 7(a) shows the longitudinal spherical aberration, wherein the transverse axis of FIG. 7(a) defines the focus, and the lengthwise axis of FIG. 7(a) defines the filed. From the vertical deviation of each curve shown in FIG. 7(a), the offset of the off-axis light relative to the image point is within ±0.01 mm. Therefore, the optical imaging lens 1 indeed eliminates aberration effectively. Additionally, the three curves presenting different wavelengths are closed to each other, and this situation represents that off-axis light with respect to these wavelengths is focused around an image point, and the aberration can be improved obviously.

FIGS. 7(b) and 7(c) respectively show the astigmatism aberration in the sagittal direction and astigmatism aberration in the tangential direction, wherein the transverse axis of FIG. 7(b) defines the focus, the lengthwise axis of FIG. 7(b) defines the image height, the transverse axis of FIG. 7(c) defines the focus, the lengthwise axis of FIG. 7(c) defines the image height. Referring to FIG. 7(b), the focus variation with respect to the three different wavelengths (470 nm, 555 nm, 650 nm) in the whole field falls within ±0.01 mm. Referring to FIG. 7(c), the focus variation with respect to the three different wavelengths (470 nm, 555 nm, 650 nm) in the whole field falls within ±0.02 mm. Therefore, the optical imaging lens 1 of the present embodiment can eliminate aberration effectively. Additionally, the three curves presenting different wavelengths may be closed to each other, and this situation may represent that the dispersion can be improved obviously. Please refer to FIG. 7(d), the transverse axis of FIG. 7(d) defines the percentage, the lengthwise axis of FIG. 7(d) defines the image height, and the variation of the distortion aberration is within ±2.5%. The variation of the distortion aberration of the present embodiment has conform to the demand of imaging quality. Additionally, the optical imaging lens of this embodiment compares with the current optical imaging lens, the total length of the optical imaging lens is shortened to 2.945 mm, the optical imaging lens 1 of the present embodiment can eliminate aberration effectively and provide better imaging quality. The optical imaging lens 1 of the example embodiment indeed achieves great optical performance and the length of the optical imaging lens 1 is effectively shortened.

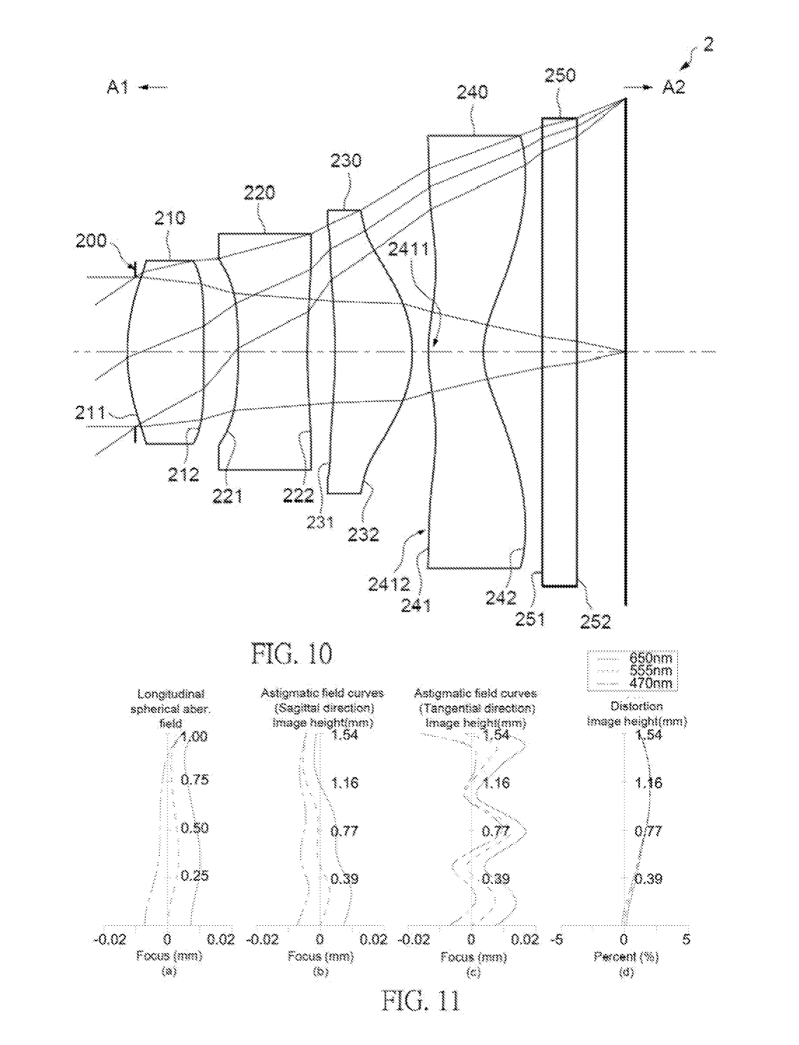

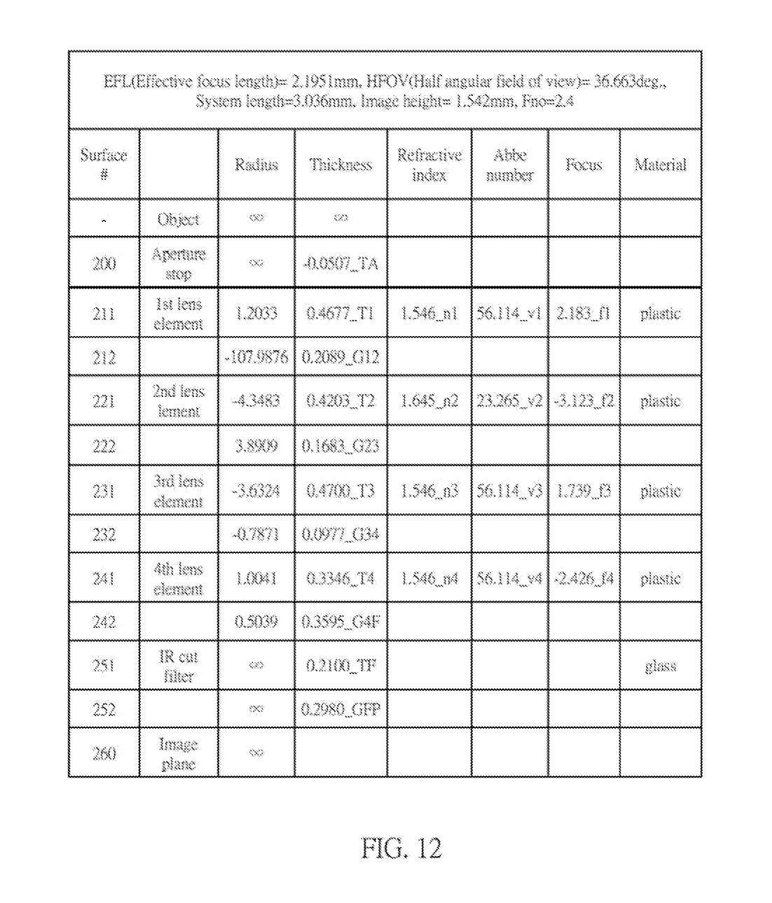

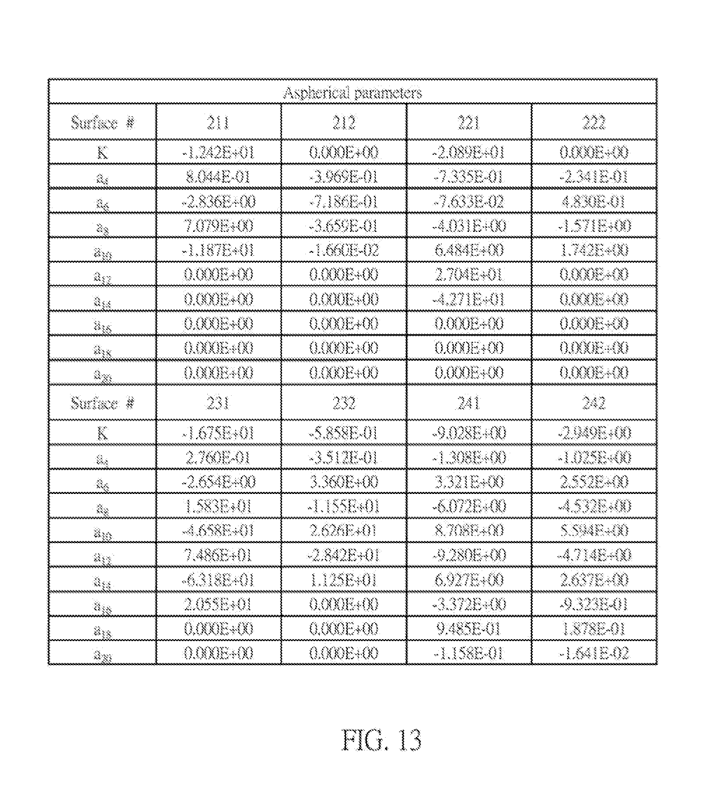

Reference is now made to FIGS. 10-13. FIG. 10 illustrates an example cross-sectional view of an optical imaging lens 2 having four lens elements of the optical imaging lens according to a second example embodiment. FIG. 11 shows example charts of longitudinal spherical aberration and other kinds of optical aberrations of the optical imaging lens 2 according to the second example embodiment. FIG. 12 shows an example table of optical data of each lens element of the optical imaging lens 2 according to the second example embodiment. FIG. 13 shows an example table of aspherical data of the optical imaging lens 2 according to the second example embodiment. The reference numbers labeled in the present embodiment are similar to those in the first embodiment for the similar elements, but here the reference numbers are initialed with 2, for example, reference number 231 for labeling the object-side surface of the third lens element 230, reference number 232 for labeling the image-side surface of the third lens element 230, etc.

As shown in FIG. 10, the optical imaging lens 2 of the present embodiment may comprise, in an order from an object side A1 to an image side A2 along an optical axis, an aperture stop 200, a first lens element 210, a second lens element 220, a third lens element 230, and a fourth lens element 240.

The differences between the second embodiment and the first embodiment are the radius of curvature, thickness of each lens element, aspherical parameters of each lens element, or the back focal length, but the configuration of the concave/convex shape of surfaces comprising the object-side surfaces 211, 221,231 facing to the object side A1 and the image-side surfaces 212, 222, 232, 242 facing to the image side A2 are similar to those in the first embodiment. Here, for clearly showing the drawings of the present embodiment, only the surface shapes which are different from that in the first embodiment are labeled. The object-side surface 241 of the fourth lens element 240 may comprise a convex portion 2411 in a vicinity of the optical axis and a concave portion 2412 in a vicinity of a periphery of the fourth lens element 240. Please refer to FIG. 8 for the optical characteristics of each lens elements in the optical imaging lens 2 the present embodiment, and please refer to FIG. 38 for the values of T1/G12, ALT/G12, ALT, ALT/AAG, T4/G23, EFL/G23, ALT/T4, AAG/G23, T3/G12, T3/T4, T1/G23, G12/G23, AAG/T1, AAG/T3, ALT/G23, T2/G23, and EFL/T3 of the present embodiment.

The distance from the object-side surface 211 of the first lens element 210 to the image plane 260 along the optical axis is 3.036 mm and the image height of the optical imaging lens 2 may be 1.542 mm. Therefore, the length of the length of the optical imaging lens 2 may be shortened compared with conventional optical imaging lenses.

FIG. 11(a) shows the longitudinal spherical aberration. From the vertical deviation of each curve shown in FIG. 11(a), the offset of the off-axis light relative to the image point may be within ±0.01 mm. Furthermore, the three curves having different wavelengths may be closed to each other, and this situation may represent that off-axis light with respect to these wavelengths is focused around an image point, and the aberration can be improved obviously.

FIGS. 11(b) and 11(c) respectively show the astigmatism aberration in the sagittal direction and astigmatism aberration in the tangential direction, Referring to FIG. 11(b), the focus variation with respect to the three different wavelengths (470 nm, 555 nm, 650 nm) in the whole field falls within +0.01 mm. Referring to FIG. 11(c), the focus variation with respect to the three different wavelengths (470 nm, 555 nm, 650 nm) in the whole field falls within ±0.02 mm. Additionally, the three curves presenting different wavelengths are closed to each other, and these closed curves represents that the dispersion is improved.

Please refer to FIG. 11(d), the variation of the distortion aberration of the optical imaging lens 2 is within ±2.5%. Therefore, the optical imaging lens 2 of the present embodiment may show great characteristics in the longitudinal spherical aberration, astigmatism in the sagittal direction, astigmatism in the tangential direction, and distortion aberration. According to above illustration, the optical imaging lens 2 of the example embodiment may indeed achieve great optical performance and the length of the optical imaging lens 2 may be effectively shortened.

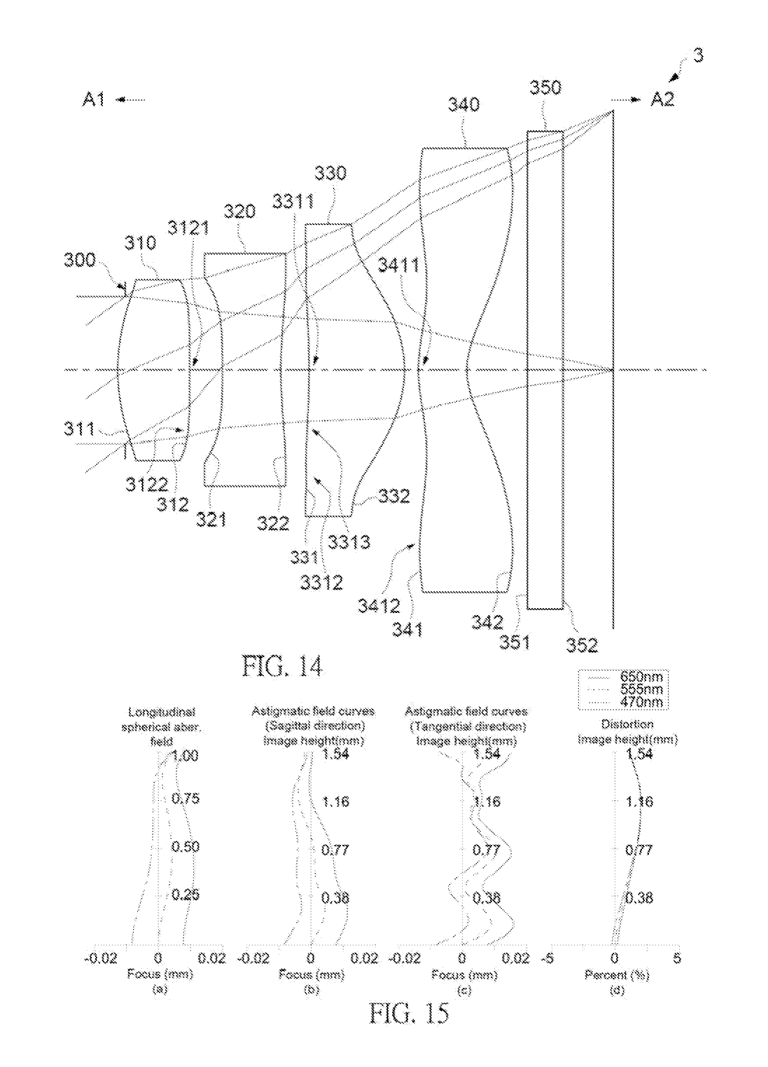

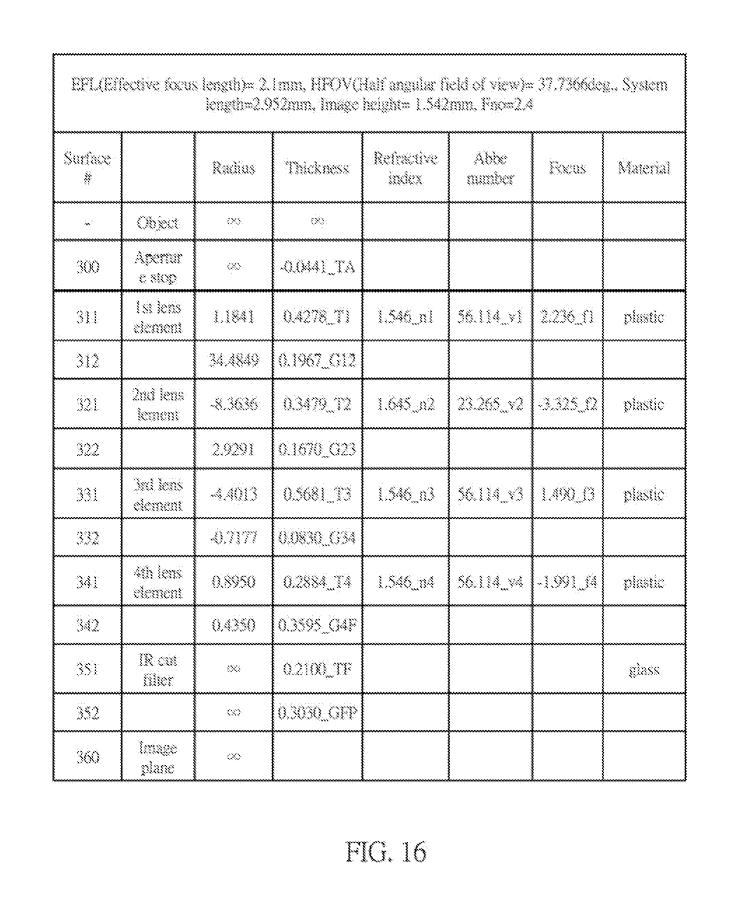

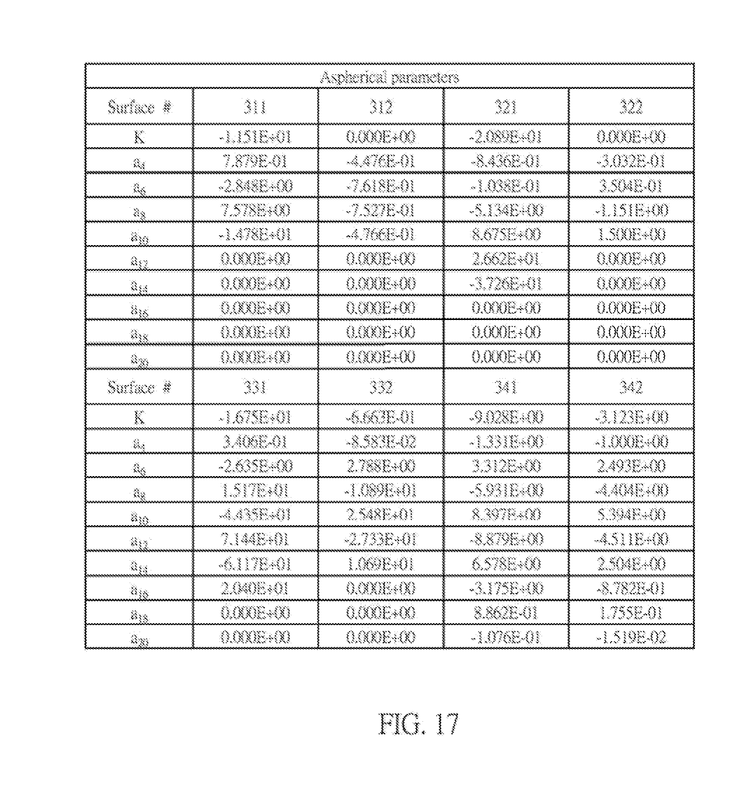

Reference is now made to FIGS. 14-17. FIG. 14 illustrates an example cross-sectional view of an optical imaging lens 3, which may comprise four lens elements of the optical imaging lens according to a third example embodiment. FIG. 15 shows example charts of longitudinal spherical aberration and other kinds of optical aberrations of the optical imaging lens 3 according to the third example embodiment. FIG. 16 shows an example table of optical data of each lens element of the optical imaging lens 3 according to the third example embodiment. FIG. 17 shows an example table of aspherical data of the optical imaging lens 3 according to the third example embodiment. The reference numbers labeled in the present embodiment are similar to those in the first embodiment for the similar elements, but here the reference numbers are initialed with 3, for example, reference number 331 for labeling the object-side surface of the third lens element 330, reference number 332 for labeling the image-side surface of the third lens element 330, etc.

As shown in FIG. 14, the optical imaging lens 3 of the present embodiment may comprise, in an order from an object side A1 to an image side A2 along an optical axis, an aperture stop 300, a first lens element 310, a second lens element 320, a third lens element 330, and a fourth lens element 340.

The configuration of the concave/convex shape of surfaces comprising the object-side surfaces 311, 321 facing to the object side A1 and the image-side surfaces 322, 332, 342 facing to the image side A2, are similar to those in the first embodiment, but the differences between the third embodiment and the first embodiment comprise the radius of curvature, thickness of each lens element, aspherical parameters of each lens element, and the back focal length. Here, for clearly showing the drawings of the present embodiment, only the surface shapes which are different from that in the first embodiment are labeled. Specifically, the image-side surface 312 of the first lens element 310 comprises a concave portion 3121 in a vicinity of the optical axis and a convex portion 3122 in a vicinity of a periphery of the first lens element 310; The object-side surface 331 of the third lens element 330 comprises a concave portion 3311 in a vicinity of the optical axis, a concave portion 3312 in a vicinity of a periphery of the third lens element 330, and a convex portion 3313 between the two concave portions 3311, 3312; The object-side surface 341 of the fourth lens element 340 comprises a convex portion 3411 in a vicinity of the optical axis and a concave portion 3412 in a vicinity of a periphery of the fourth lens element 340. FIG. 16 depicts the optical characteristics of each lens elements in the optical imaging lens 3 of the present embodiment, and please refer to FIG. 38 for the values of T1/G12, ALT/G12, ALT, ALT/AAG, T4/G23, EFL/G23, ALT/T4, AAG/G23, T3/G12, T3/T4, T1/G23, G12/G23, AAG/T1, AAG/T3, ALT/G23, T2/G23, and EFL/T3 of the present embodiment.

The distance from the object-side surface 311 of the first lens element 310 to the image plane 360 along the optical axis is 2.952 mm and the image height of the optical imaging lens 3 may be 1.542 mm. Therefore, the length of the optical imaging lens 3 may be shortened compared with conventional optical imaging lenses.

FIG. 15(a) shows the longitudinal spherical aberration. From the vertical deviation of each curve shown in FIG. 15(a), the offset of the off-axis light relative to the image point may be within ±0.02 mm. Furthermore, the three curves having different wavelengths may be closed to each other, and this situation may represent that off-axis light with respect to these wavelengths is focused around an image point, and the aberration can be improved obviously.

FIGS. 15(b) and 15(c) respectively show the astigmatism aberration in the sagittal direction and astigmatism aberration in the tangential direction. Referring to FIG. 15(b), the focus variation with respect to the three different wavelengths (470 nm, 555 nm, 650 nm) in the whole field falls within ±0.01 mm. Referring to FIG. 15(c), the focus variation with respect to the three different wavelengths (470 nm, 555 nm, 650 nm) in the whole field falls within ±0.02 mm. Additionally, the three curves presenting different wavelengths are closed to each other, and these closed curves represents that the dispersion is improved. Please refer to FIG. 15(d), the variation of the distortion aberration of the optical imaging lens 3 is within ±2.5%. Therefore, the optical imaging lens 3 of the present embodiment may show great characteristics in the longitudinal spherical aberration, astigmatism in the sagittal direction, astigmatism in the tangential direction, and distortion aberration. According to above illustration, the optical imaging lens 3 of the example embodiment may indeed achieve great optical performance and the length of the optical imaging lens 3 is effectively shortened.

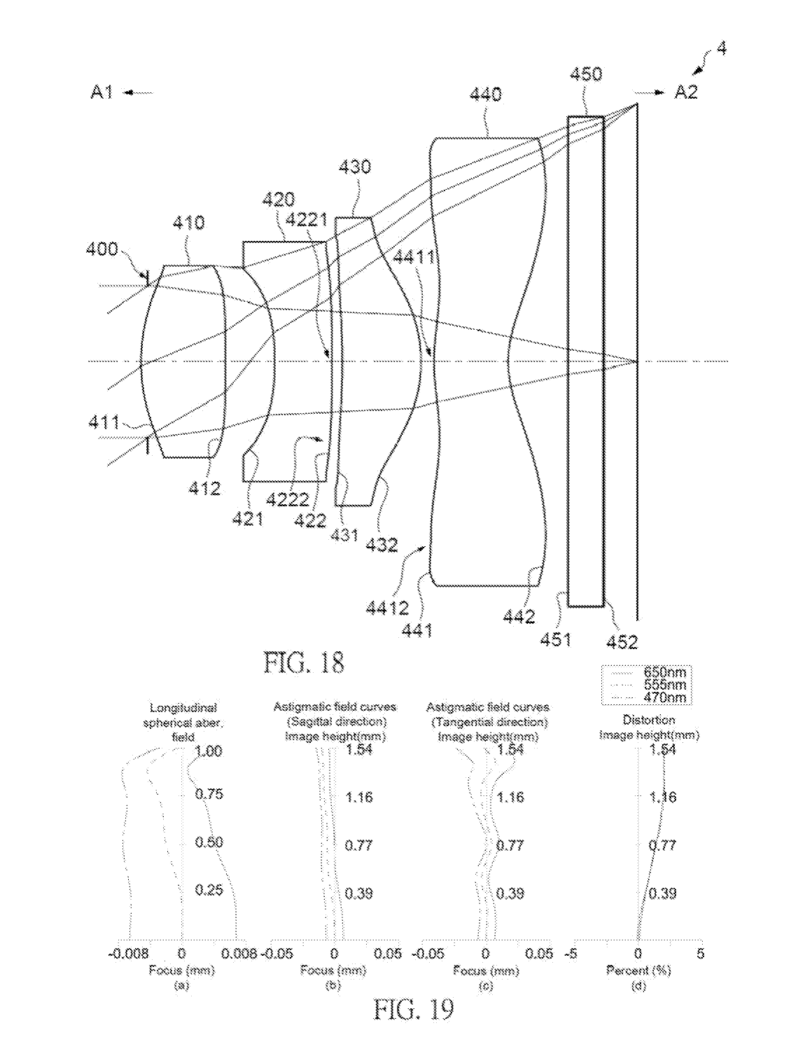

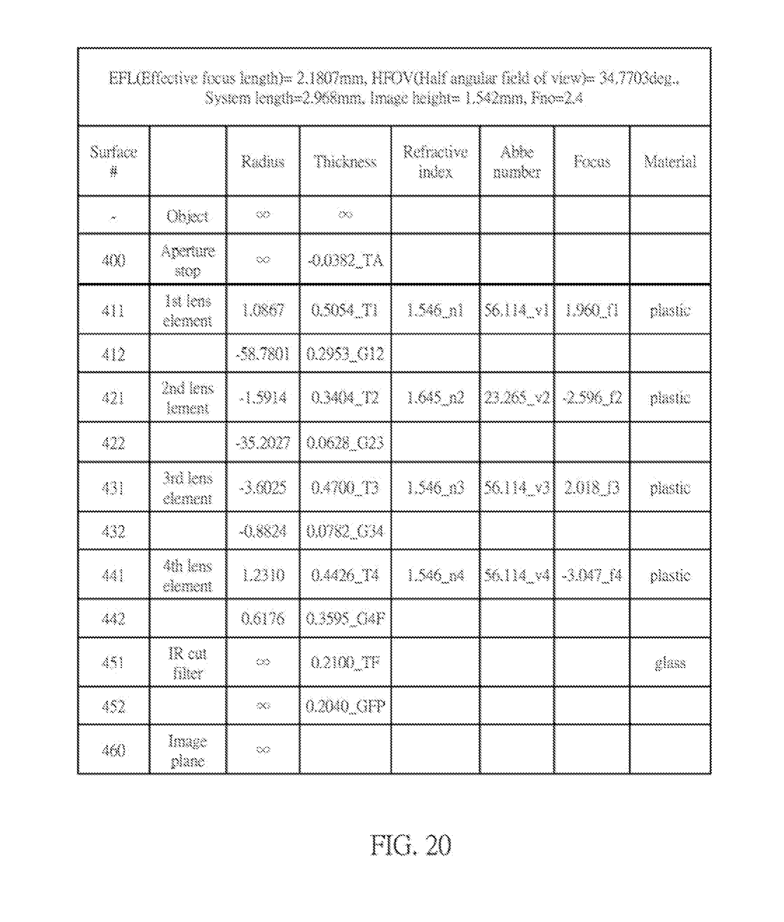

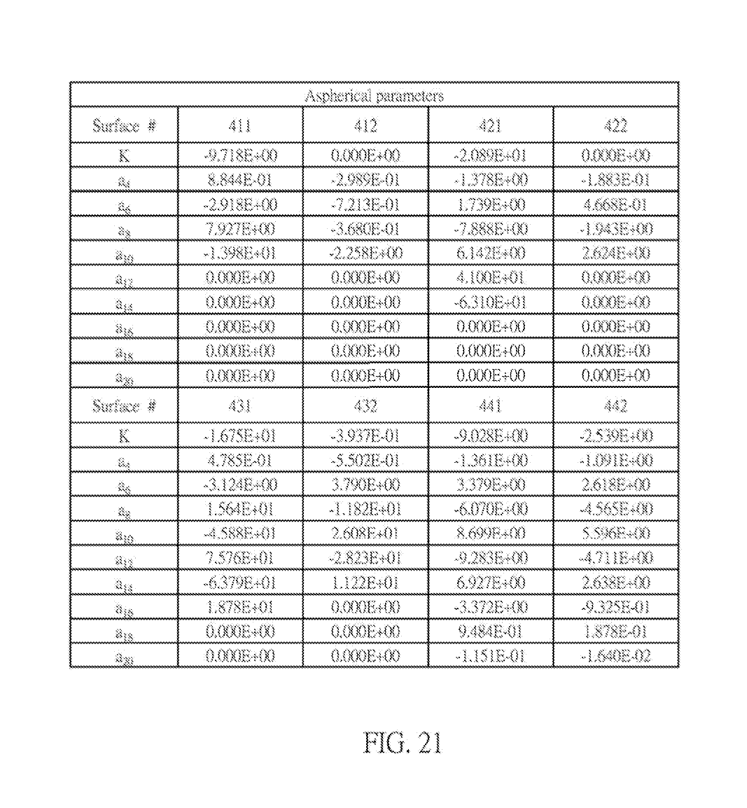

Reference is now made to FIGS. 18-21. FIG. 18 illustrates an example cross-sectional view of an optical imaging lens 4 having four lens elements of the optical imaging lens according to a fourth example embodiment. FIG. 19 shows example charts of longitudinal spherical aberration and other kinds of optical aberrations of the optical imaging lens 4 according to the fourth embodiment. FIG. 20 shows an example table of optical data of each lens element of the optical imaging lens 4 according to the fourth example embodiment. FIG. 21 shows an example table of aspherical data of the optical imaging lens 4 according to the fourth example embodiment. The reference numbers labeled in the present embodiment are similar to those in the first embodiment for the similar elements, but here the reference numbers are initialed with 4, for example, reference number 431 for labeling the object-side surface of the third lens element 430, reference number 432 for labeling the image-side surface of the third lens element 430, etc.

As shown in FIG. 18, the optical imaging lens 4 of the present embodiment, in an order from an object side A1 to an image side A2 along an optical axis, may comprise an aperture stop 400, a first lens element 410, a second lens element 420, a third lens element 430, and a fourth lens element 440.

The configuration of the concave/convex shape of surfaces, comprising the object-side surfaces 411, 421, 431 facing to the object side A1 and the image-side surfaces 412, 432, 442 facing to the image side A2, are similar to those in the first embodiment, but the differences between the fourth embodiment and the first embodiment are the radius of curvature, thickness of each lens element, aspherical parameters of each lens element, the back focal length, and the configuration of the concave/convex shape of the object-side surface 441 and image-side surface 422. Here, for clearly showing the drawings of the present embodiment, only the surface shapes which are different from that in the first embodiment are labeled. Specifically, the image-side surface 422 of the second lens element 420 is a convex surface comprising a convex portion 4221 in a vicinity of the optical axis and a convex portion 4222 in a vicinity of a periphery of the second lens element 420; the object-side surface 441 of the fourth lens element 440 may comprise a convex portion 4411 in a vicinity of the optical axis and a concave portion 4412 in a vicinity of a periphery of the fourth lens element 440. FIG. 20 depicts the optical characteristics of each lens elements in the optical imaging lens 4 of the present embodiment, and please refer to FIG. 38 for the values of T1/G12, ALT/G12, ALT, ALT/AAG, T4/G23, EFL/G23, ALT/T4, AAG/G23, T3/G12, T3/T4, T1/G23, G12/G23, AAG/T1, AAG/T3, ALT/G23, T2/G23, and EFL/T3 of the present embodiment.

The distance from the object-side surface 411 of the first lens element 410 to the image plane 460 along the optical axis is 2.968 mm and the image height of the optical imaging lens 4 is 1.542 mm. Therefore, the length of the optical imaging lens 4 may be shortened compared with conventional optical imaging lenses.

FIG. 19(a) shows the longitudinal spherical aberration. From the vertical deviation of each curve shown in FIG. 19(a), the offset of the off-axis light relative to the image point is within ±0.008 mm. Furthermore, the three curves having different wavelengths are closed to each other, and this situation represents that off-axis light with respect to these wavelengths may be focused around an image point, and the aberration can be improved obviously. FIGS. 19(b) and 19(c) respectively show the astigmatism aberration in the sagittal direction and astigmatism aberration in the tangential direction. Referring to FIG. 19(b), the focus variation with respect to the three different wavelengths (470 nm, 555 nm, 650 nm) in the whole field falls within ±0.025 mm. Referring to FIG. 19(c), the focus variation with respect to the three different wavelengths (470 nm, 555 nm, 650 nm) in the whole field falls within ±0.025 mm. Additionally, the three curves presenting different wavelengths are closed to each other, and these closed curves represents that the dispersion is improved. Please refer to FIG. 19(d), the variation of the distortion aberration of the optical imaging lens 4 is within ±2.5%. Therefore, the optical imaging lens 4 of the present embodiment shows great characteristics in the longitudinal spherical aberration, astigmatism in the sagittal direction, astigmatism in the tangential direction, and distortion aberration. According to above illustration, the optical imaging lens 4 of the example embodiment indeed achieves great optical performance and the length of the optical imaging lens 4 is effectively shortened.

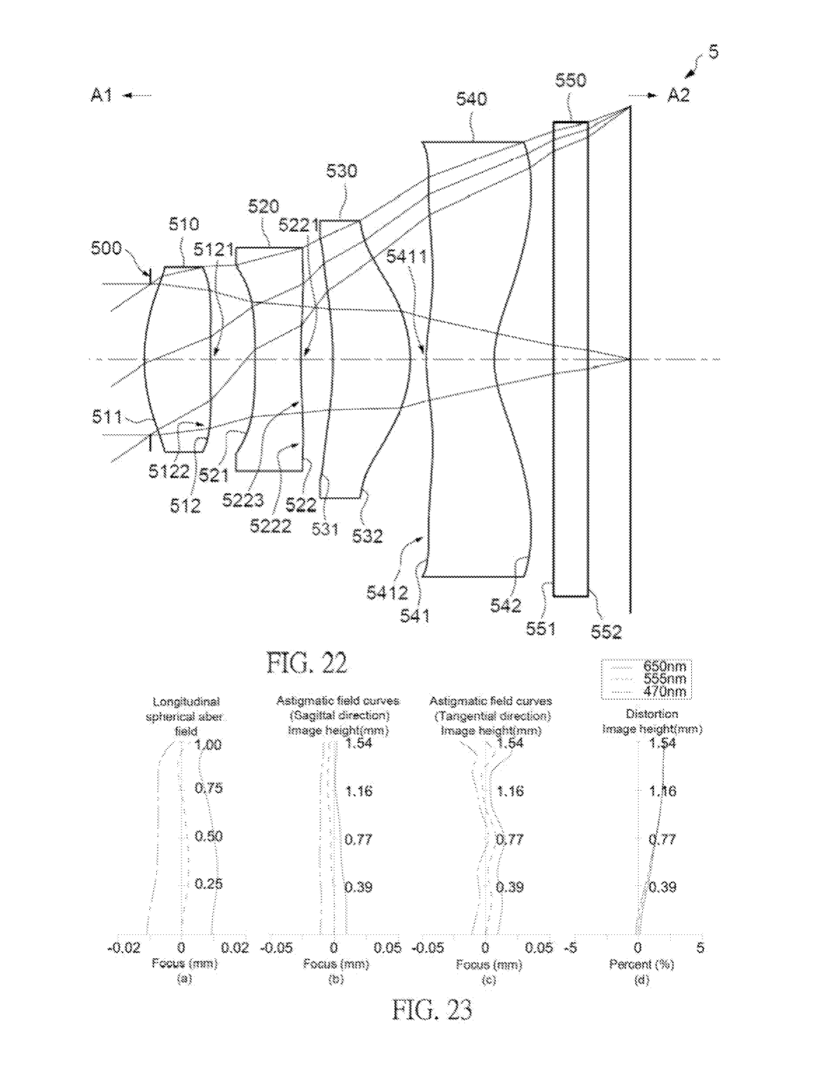

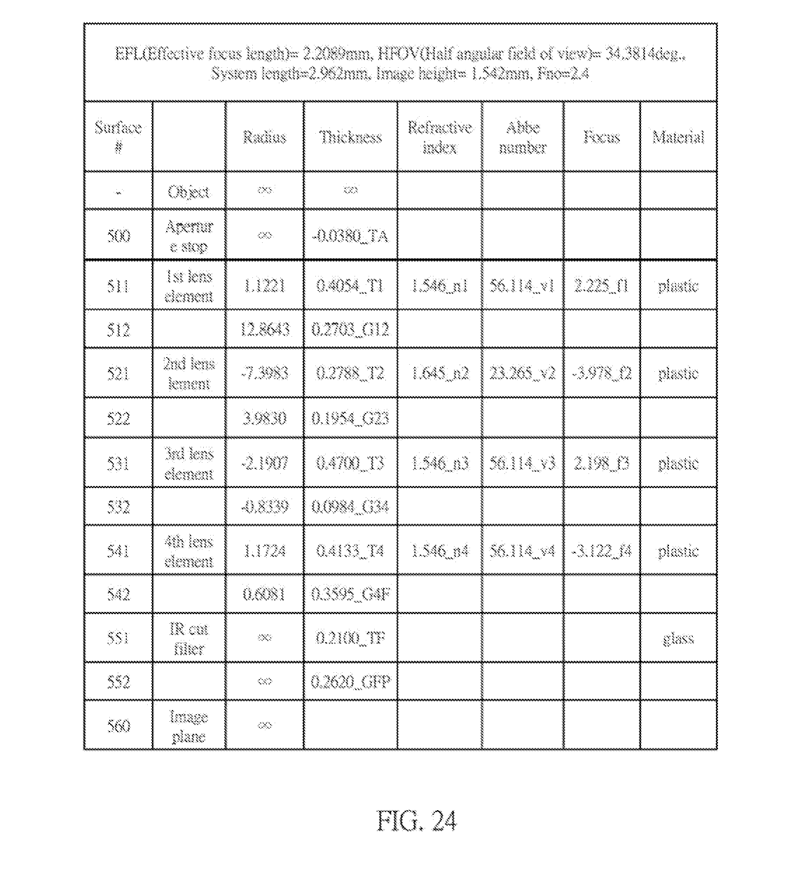

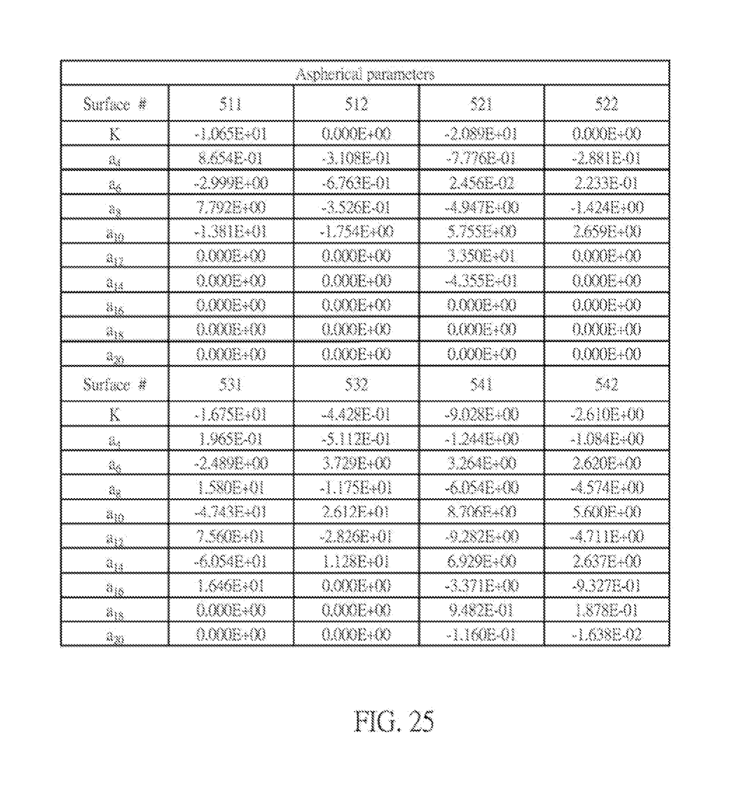

Reference is now made to FIGS. 22-25. FIG. 22 illustrates an example cross-sectional view of an optical imaging lens 5 having four lens elements of the optical imaging lens according to a fifth example embodiment. FIG. 23 shows example charts of longitudinal spherical aberration and other kinds of optical aberrations of the optical imaging lens 5 according to the fifth embodiment. FIG. 24 shows an example table of optical data of each lens element of the optical imaging lens 5 according to the fifth example embodiment. FIG. 25 shows an example table of aspherical data of the optical imaging lens 5 according to the fifth example embodiment. The reference numbers labeled in the present embodiment are similar to those in the first embodiment for the similar elements, but here the reference numbers are initialed with 5, for example, reference number 531 for labeling the object-side surface of the third lens element 530, reference number 532 for labeling the image-side surface of the third lens element 530, etc.

As shown in FIG. 22, the optical imaging lens 5 of the present embodiment may comprise, in an order from an object side A1 to an image side A2 along an optical axis, an aperture stop 500, a first lens element 510, a second lens element 520, a third lens element 530, and a fourth lens element 540.

The configuration of the concave/convex shape of surfaces comprising the object-side surfaces 511, 521, 531 facing to the object side A1 and the image-side surfaces 532, 542 facing to the image side A2, are similar to those in the first embodiment. The differences between the fifth embodiment and the first embodiment are the radius of curvature, thickness of each lens element, aspherical parameters of each lens element, the back focal length, and the configuration of the concave/convex shape of the object-side surface 541 and image-side surfaces 512, 522. Here, for clearly showing the drawings of the present embodiment, only the surface shapes which are different from that in the first embodiment are labeled. Specifically, the image-side surface 512 of the first lens element 510 may comprise a concave portion 5121 in a vicinity of the optical axis and a convex portion 5122 in a vicinity of a periphery of the first lens element 510; the image-side surface 522 of the second lens element 520 may comprise a concave portion 5221 in a vicinity of the optical axis 5221, a concave portion 5222 in a vicinity of a periphery of the second lens element 520, and a convex portion 5223 between the two concave portions 5221, 5222; the object-side surface 541 of the fourth lens element 540 may comprise a convex portion 5411 in a vicinity of the optical axis and a concave portion 5412 in a vicinity of a periphery of the fourth lens element 540. FIG. 24 depicts the optical characteristics of each lens elements in the optical imaging lens 5 of the present embodiment, and please refer to FIG. 38 for the values of T1/G12, ALT/G12, ALT, ALT/AAG, T4/G23, EFL/G23, ALT/T4, AAG/G23, T3/G12, T3/T4, T1/G23, G12/G23, AAG/T1, AAG/T3, ALT/G23, T2/G23, and EFL/T3 of the present disclosure.

The distance from the object-side surface 511 of the first lens element 510 to the image plane 560 along the optical axis is 2.962 mm and the image height of the optical imaging lens 5 may be 1.541 mm. Therefore, the length of the optical imaging lens 5 may be shortened compared with conventional optical imaging lenses.

FIG. 23(a) shows the longitudinal spherical aberration of the first embodiment. From the vertical deviation of each curve shown in FIG. 23(a), the offset of the off-axis light relative to the image point may be within ±0.015 mm. Furthermore, the three curves having different wavelengths are closed to each other, and this situation represents that off-axis light with respect to these wavelengths is focused around an image point, and the aberration can be improved obviously.

FIGS. 23(b) and 23(c) respectively show the astigmatism aberration in the sagittal direction and astigmatism aberration in the tangential direction. Referring to FIG. 23(b), the focus variation with respect to the three different wavelengths (470 nm, 555 nm, 650 nm) in the whole field may fall within ±0.025 mm. Referring to FIG. 23(c), the focus variation with respect to the three different wavelengths (470 nm, 555 nm, 650 nm) in the whole field may fall within ±0.025 mm. Additionally, the three curves presenting different wavelengths are closed to each other, and these closed curves represents that the dispersion is improved. Please refer to FIG. 23(d), the variation of the distortion aberration of the optical imaging lens 5 may be within ±2.5%. Therefore, the optical imaging lens 5 of the present embodiment may show great characteristics in the longitudinal spherical aberration, astigmatism in the sagittal direction, astigmatism in the tangential direction, and distortion aberration. According to above illustration, the optical imaging lens 5 of the example embodiment indeed achieves great optical performance and the length of the optical imaging lens 5 may be effectively shortened.

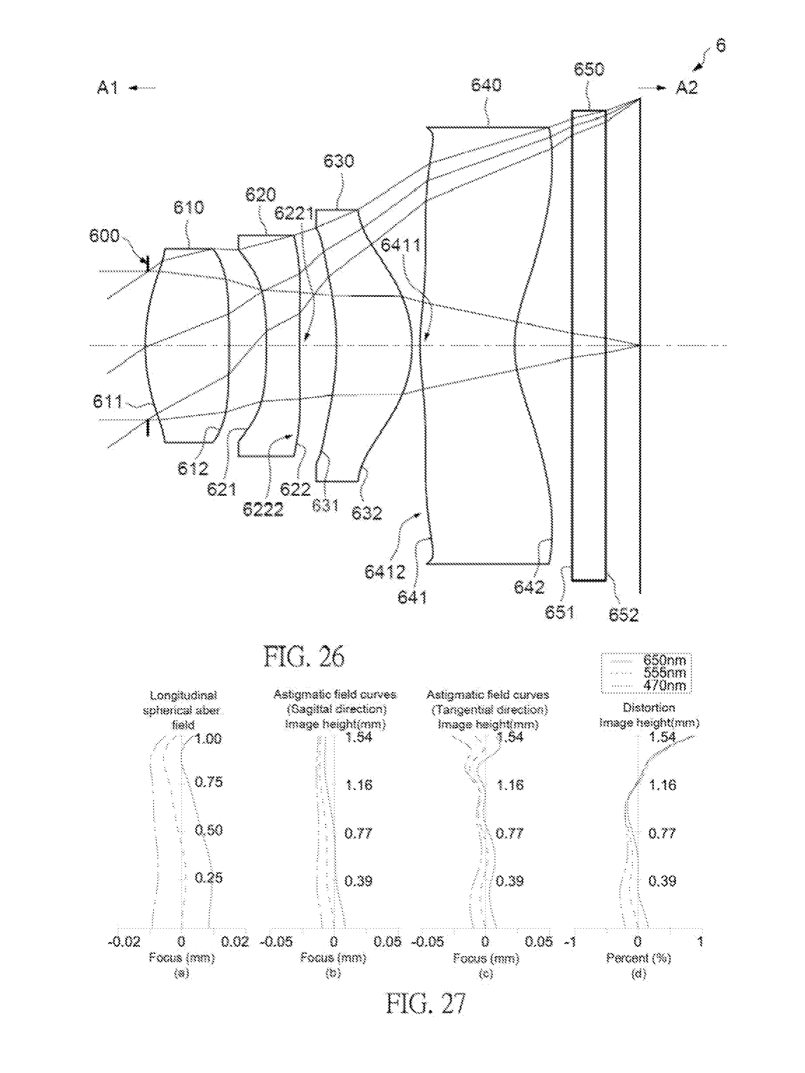

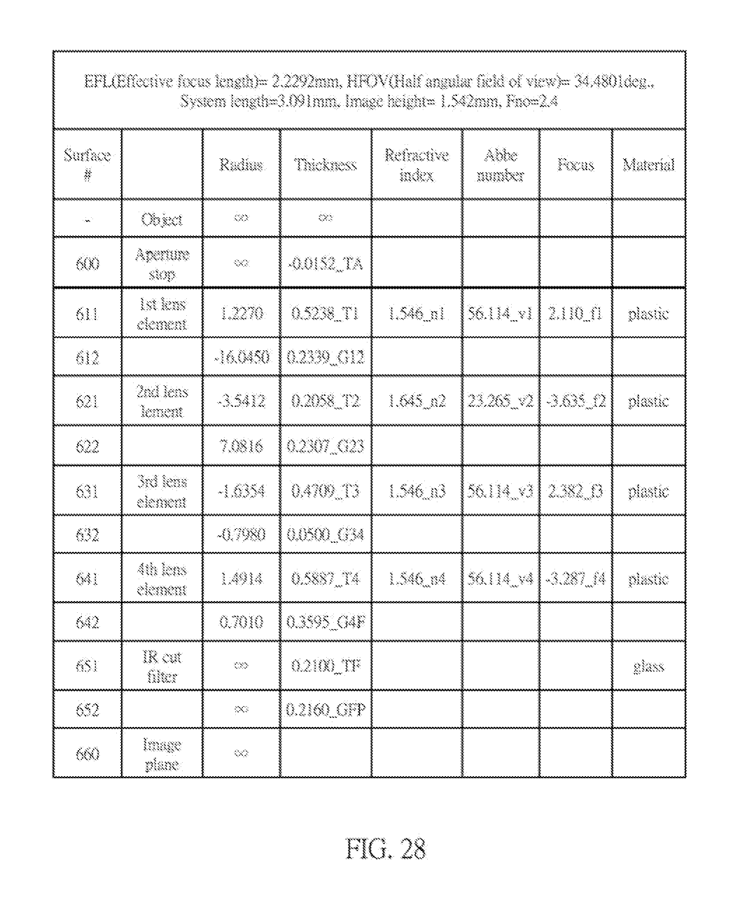

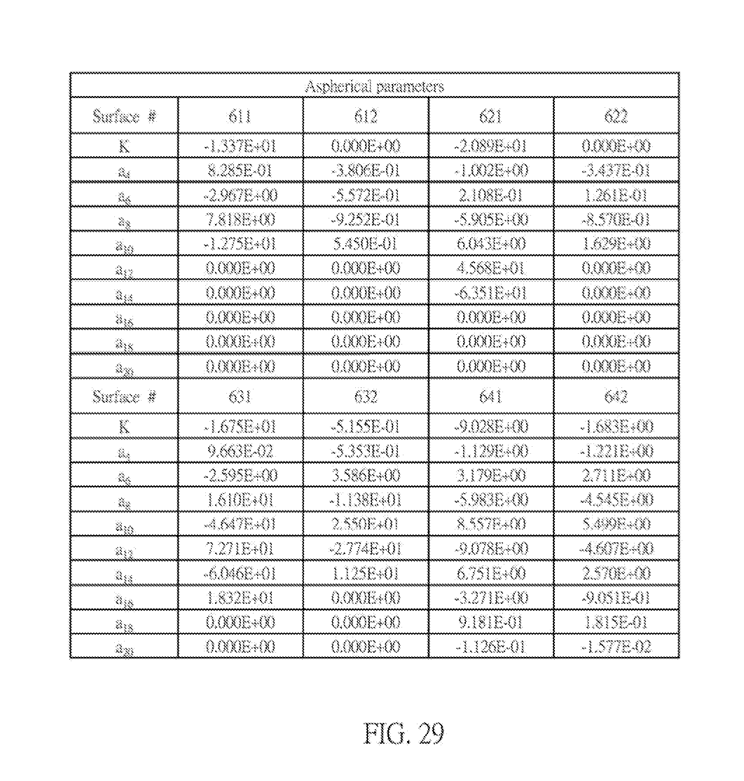

Reference is now made to FIGS. 26-29. FIG. 26 illustrates an example cross-sectional view of an optical imaging lens 6 having four lens elements of the optical imaging lens according to a sixth example embodiment. FIG. 27 shows example charts of longitudinal spherical aberration and other kinds of optical aberrations of the optical imaging lens 6 according to the sixth embodiment. FIG. 28 shows an example table of optical data of each lens element of the optical imaging lens 6 according to the sixth example embodiment. FIG. 29 shows an example table of aspherical data of the optical imaging lens 6 according to the sixth example embodiment. The reference numbers labeled in the present embodiment are similar to those in the first embodiment for the similar elements, but here the reference numbers are initialed with 6, for example, reference number 631 for labeling the object-side surface of the third lens element 630, reference number 632 for labeling the image-side surface of the third lens element 630, etc.

As shown in FIG. 26, the optical imaging lens 6 of the present embodiment may comprise, in an order from an object side A1 to an image side A2 along an optical axis, an aperture stop 600, a first lens element 610, a second lens element 620, a third lens element 630, and a fourth lens element 640. The differences between the sixth embodiment and the first embodiment are the radius of curvature, thickness of each lens element, aspherical parameters of each lens element, the back focal length, and the configuration of the concave/convex shape of the object-side surface 641 and image-side surface 622, but the configuration of the concave/convex shape of surfaces, may comprise the object-side surfaces 611, 621, 631 facing to the object side A1 and the image-side surfaces 612, 632, 642 facing to the image side A2, are similar to those in the first embodiment. Here, for clearly showing the drawings of the present embodiment, only the surface shapes which are different from that in the first embodiment are labeled. Specifically, the image-side surface 622 of the second lens element 620 may comprise a concave portion 6221 in a vicinity of the optical axis and a convex portion 6222 in a vicinity of a periphery of the second lens element 620; the object-side surface 641 of the fourth lens element 640 is a convex surface which may comprise a convex portion 6411 in a vicinity of the optical axis and a convex portion 6412 in a vicinity of a periphery of the fourth lens element 640. FIG. 28 depicts the optical characteristics of each lens elements in the optical imaging lens 6 of the present embodiment. Please refer to FIG. 38 for the values of T1/G12, ALT/G12, ALT, ALT/AAG, T4/G23, EFL/G23, ALT/T4, AAG/G23, T3/G12, T3/T4, T1/G23, G12/G23, AAG/T1, AAG/T3, ALT/G23, T2/G23, and EFL/T3 of the present embodiment.

The distance from the object-side surface 611 of the first lens element 610 to the image plane 660 along the optical axis may be 3.091 mm and the image height of the optical imaging lens 6 may be 1.542 mm. Therefore, the length of the optical imaging lens 6 may be shortened compared with conventional optical imaging lenses.

FIG. 27(a) shows the longitudinal spherical aberration. From the vertical deviation of each curve shown in FIG. 27(a), the offset of the off-axis light relative to the image point may be within ±0.01 mm. Furthermore, the three curves having different wavelengths may be closed to each other, and this situation represents that off-axis light with respect to these wavelengths may be focused around an image point, and the aberration can be improved obviously.

FIGS. 27(b) and 27(c) respectively show the astigmatism aberration in the sagittal direction and astigmatism aberration in the tangential direction. Referring to FIG. 27(b), the focus variation with respect to the three different wavelengths (470 nm, 555 nm, 650 nm) in the whole field may fall within +0.01 mm. Referring to FIG. 27(c), the focus variation with respect to the three different wavelengths (470 nm, 555 nm, 650 nm) in the whole field may fall within ±0.025 mm. Additionally, the three curves presenting different wavelengths may be closed to each other, and these closed curves may represent that the dispersion is improved. Please refer to FIG. 27(d), the variation of the distortion aberration of the optical imaging lens 6 may be within +1.0%. Therefore, the optical imaging lens 6 of the present embodiment may exhibit great characteristics in the longitudinal spherical aberration, astigmatism in the sagittal direction, astigmatism in the tangential direction, and distortion aberration. According to above illustration, the optical imaging lens 6 of the example embodiment may indeed achieve great optical performance and the length of the optical imaging lens 6 may be effectively shortened.

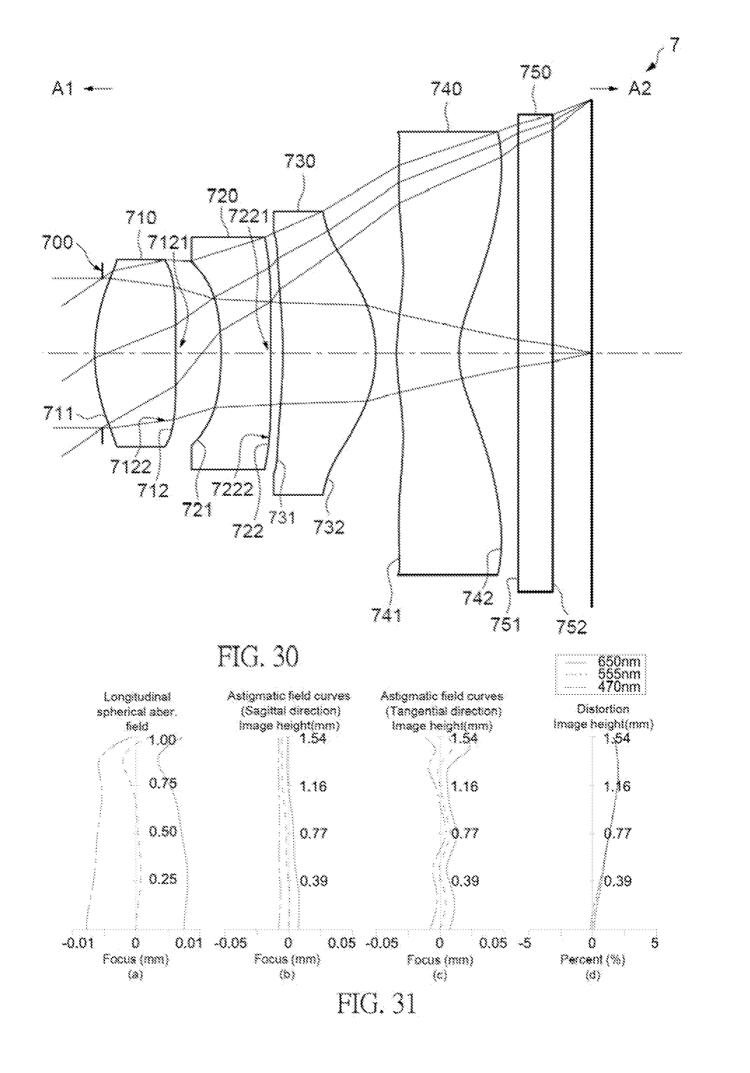

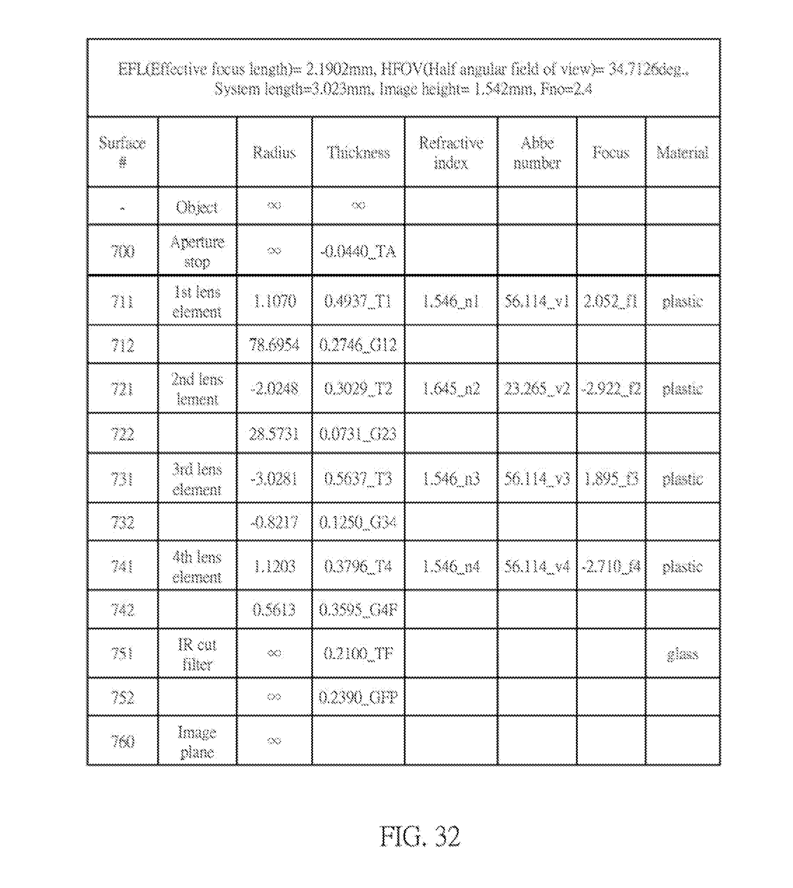

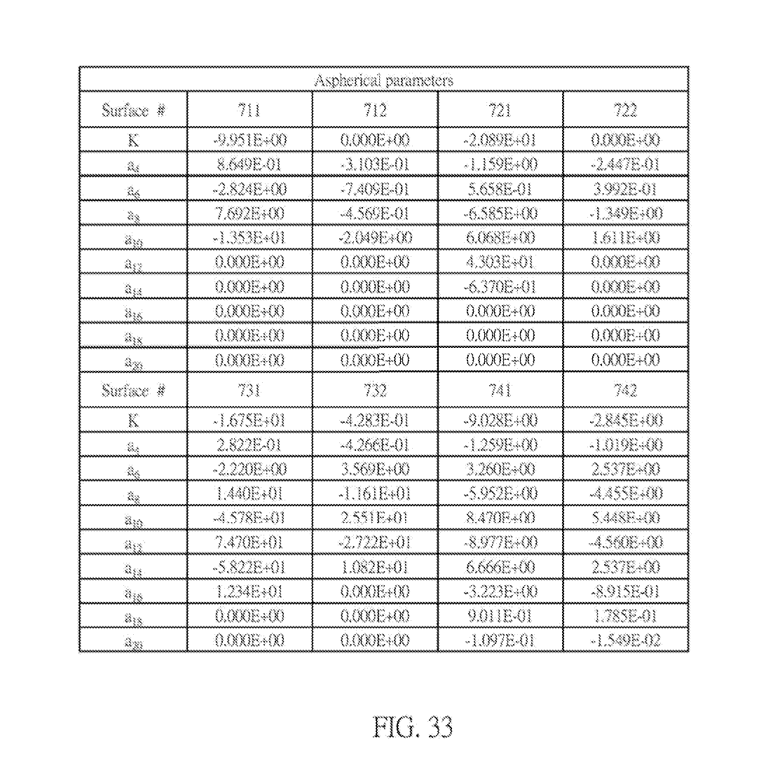

Reference is now made to FIGS. 30-33. FIG. 30 illustrates an example cross-sectional view of an optical imaging lens 7 having four lens elements of the optical imaging lens according to a seventh example embodiment. FIG. 31 shows example charts of longitudinal spherical aberration and other kinds of optical aberrations of the optical imaging lens 7 according to the seventh embodiment. FIG. 32 shows an example table of optical data of each lens element of the optical imaging lens 7 according to the seventh example embodiment. FIG. 33 shows an example table of aspherical data of the optical imaging lens 7 according to the seventh example embodiment. The reference numbers labeled in the present embodiment are similar to those in the first embodiment for the similar elements, but here the reference numbers are initialed with 7, for example, reference number 731 for labeling the object-side surface of the third lens element 730, reference number 732 for labeling the image-side surface of the third lens element 730, etc.

As shown in FIG. 30, the optical imaging lens 7 of the present embodiment may comprise, in an order from an object side A1 to an image side A2 along an optical axis, an aperture stop 700, a first lens element 710, a second lens element 720, a third lens element 730, and a fourth lens element 740.

The differences between the seventh embodiment and the first embodiment are the radius of curvature, thickness of each lens element, aspherical parameters of each lens element, the back focal length and the configuration of the concave/convex shape of the object-side surfaces 712, 722, but the configuration of the concave/convex shape of surfaces, comprising the object-side surfaces 711, 721, 731, 741 facing to the object side A1 and the image-side surfaces 732, 742 facing to the image side A2, are similar to those in the first embodiment. Here, for clearly showing the drawings of the present embodiment, only the surface shapes which are different from that in the first embodiment are labeled. Specifically, the image-side surface 712 of the first lens element 710 comprises a concave portion 7121 in a vicinity of the optical axis and a convex portion 7122 in a vicinity of a periphery of the first lens element 710; the image-side surface 722 of the second lens element 720 comprises a concave portion 7221 in a vicinity of the optical axis and a convex portion 7222 in a vicinity of a periphery of the second lens element 720. FIG. 32 depicts the optical characteristics of each lens elements in the optical imaging lens 7 of the present embodiment, and please refer to FIG. 38 for the values of T1/G12, ALT/G12, ALT, ALT/AAG, T4/G23, EFL/G23, ALT/T4, AAG/G23, T3/G12, T3/T4, T1/G23, G12/G23, AAG/T1, AAG/T3, ALT/G23, T2/G23, and EFL/T3 of the present embodiment.

The distance from the object-side surface 711 of the first lens element 710 to the image plane 760 along the optical axis is 3.023 mm and the image height of the optical imaging lens 7 may be 1.542 mm. Therefore, the length of the optical imaging lens 7 may be shortened compared with conventional optical imaging lenses.

FIG. 31(a) shows the longitudinal spherical aberration. From the vertical deviation of each curve shown in FIG. 31(a), the offset of the off-axis light relative to the image point may be within ±0.01 mm. Furthermore, the three curves having different wavelengths may be closed to each other, and this situation may represent that off-axis light with respect to these wavelengths is focused around an image point, and the aberration can be improved obviously.

FIGS. 31(b) and 31(c) respectively show the astigmatism aberration in the sagittal direction and astigmatism aberration in the tangential direction. Referring to FIG. 31(b), the focus variation with respect to the three different wavelengths (470 nm, 555 nm, 650 nm) in the whole field may fall within ±0.025 mm. Referring to FIG. 31(c), the focus variation with respect to the three different wavelengths (470 nm, 555 nm, 650 nm) in the whole field may fall within ±0.025 mm. Additionally, the three curves presenting different wavelengths may be closed to each other, and these closed curves may represent that the dispersion is improved. Please refer to FIG. 31(d), the variation of the distortion aberration of the optical imaging lens 7 is within ±2.5%. Therefore, the optical imaging lens 7 of the present embodiment shows great characteristics in the longitudinal spherical aberration, astigmatism in the sagittal direction, astigmatism in the tangential direction, and distortion aberration. According to above illustration, the optical imaging lens 7 of the example embodiment may indeed achieve great optical performance and the length of the optical imaging lens 7 is effectively shortened.

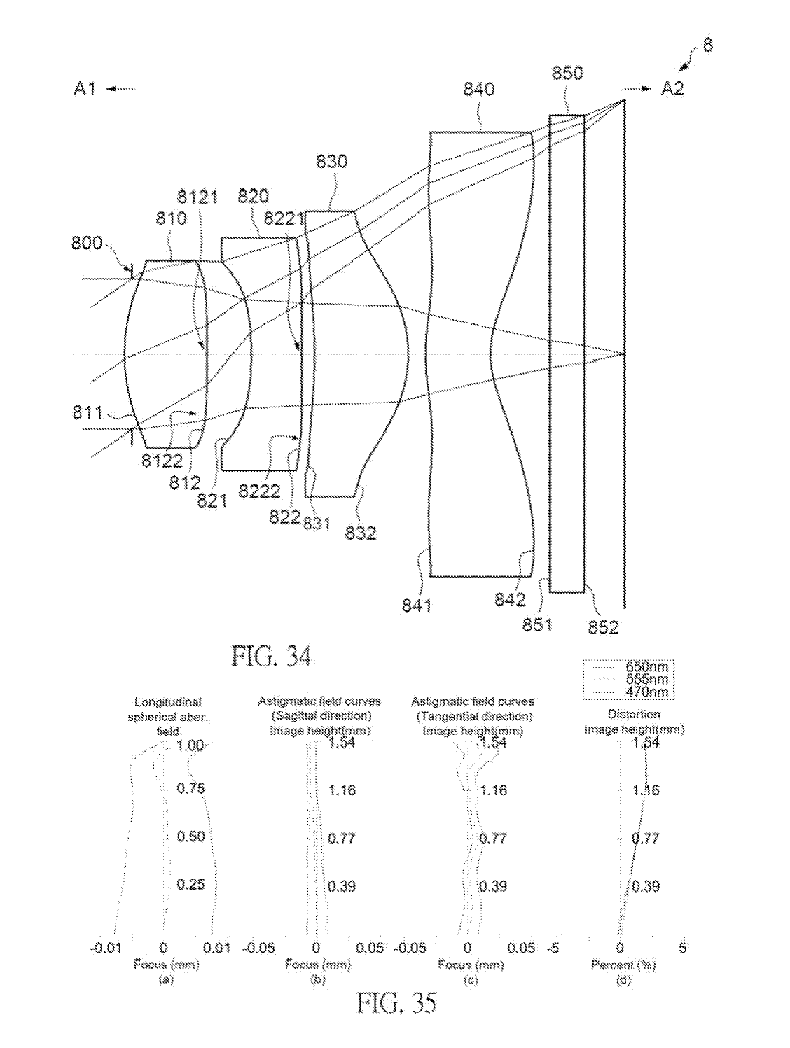

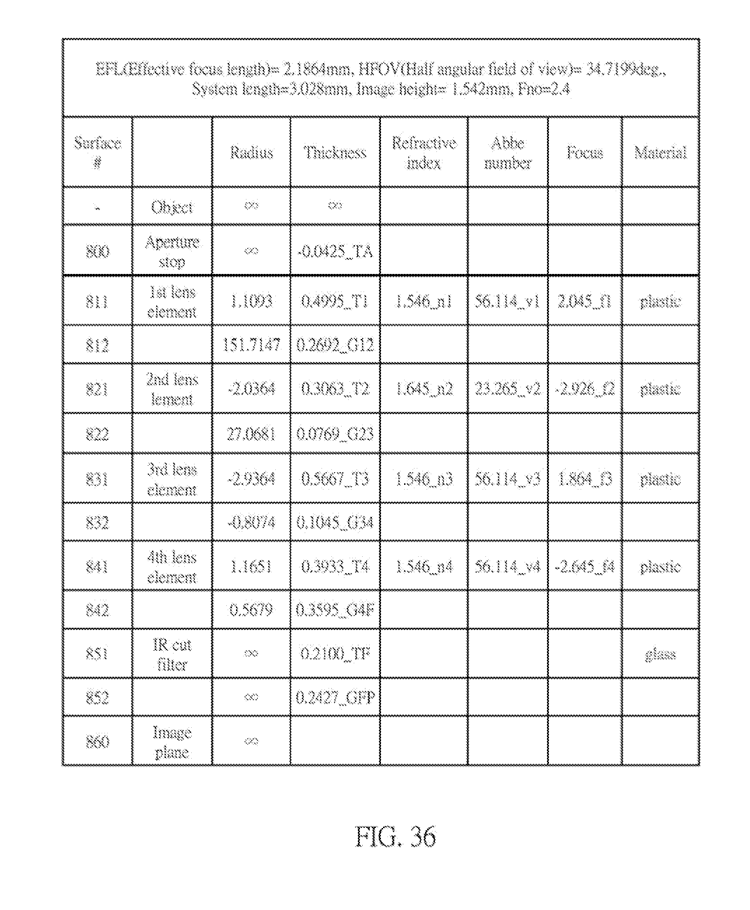

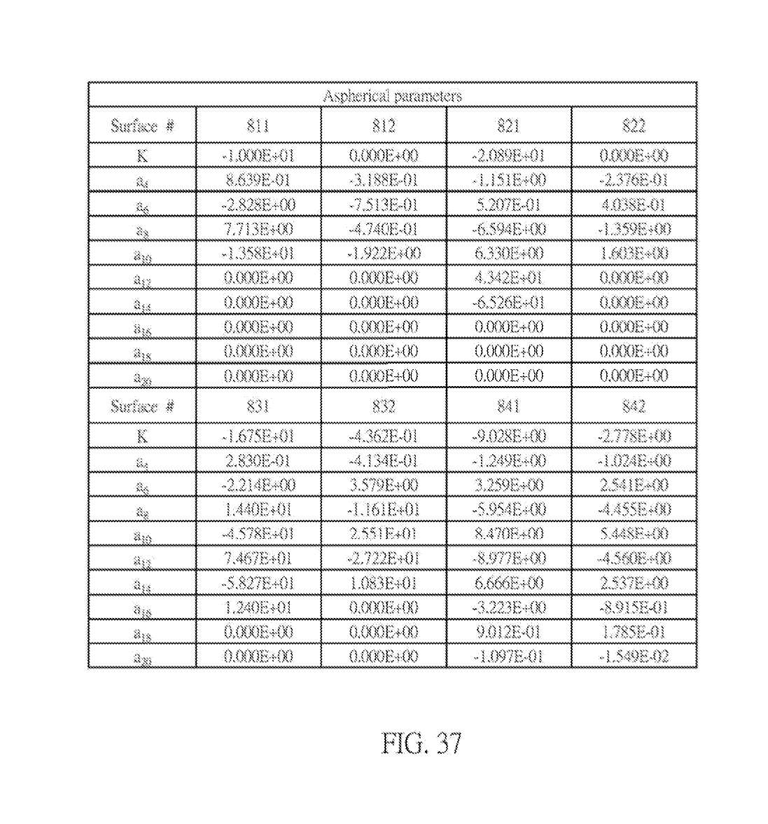

Reference is now made to FIGS. 34-37. FIG. 34 illustrates an example cross-sectional view of an optical imaging lens 8 which may have four lens elements of the optical imaging lens according to an eighth example embodiment. FIG. 35 shows example charts of longitudinal spherical aberration and other kinds of optical aberrations of the optical imaging lens 8 according to the eighth embodiment. FIG. 36 shows an example table of optical data of each lens element of the optical imaging lens 8 according to the eighth example embodiment. FIG. 37 shows an example table of aspherical data of the optical imaging lens 8 according to the eighth example embodiment. The reference numbers labeled in the present embodiment are similar to those in the first embodiment for the similar elements, but here the reference numbers are initialed with 8, for example, reference number 831 for labeling the object-side surface of the third lens element 830, reference number 832 for labeling the image-side surface of the third lens element 830, etc.

As shown in FIG. 34, the optical imaging lens 8 of the present embodiment may comprise, in an order from an object side A1 to an image side A2 along an optical axis, an aperture stop 800, a first lens element 810, a second lens element 820, a third lens element 830, and a fourth lens element 840.

The differences between the eighth embodiment and the first embodiment are the radius of curvature, thickness of each lens element, aspherical parameters of each lens element, the back focal length, and the configuration of the concave/convex shape of the image-side surfaces 812, 822, but the configuration of the concave/convex shape of surfaces, comprising the object-side surfaces 811, 821, 831, 841 facing to the object side A1 and the image-side surfaces, 832, 842 facing to the image side A2, are similar to those in the first embodiment. Here, for clearly showing the drawings of the present embodiment, only the surface shapes which are different from that in the first embodiment are labeled. Specifically, the image-side surface 812 of the first lens element 810 comprises a concave portion 8121 in a vicinity of the optical axis and a convex portion 8122 in a vicinity of a periphery of the first lens element 810; the image-side surface 822 of the second lens element 820 comprises a concave portion 8221 in a vicinity of the optical axis and a convex portion 8222 in a vicinity of a periphery of the second lens element 820. FIG. 36 depicts the optical characteristics of each lens elements in the optical imaging lens 8 of the present embodiment, and please refer to FIG. 38 for the values of T1/G12, ALT/G12, ALT, ALT/AAG, T4/G23, EFL/G23, ALT/T4, AAG/G23, T3/G12, T3/T4, T1/G23, G12/G23, AAG/T1, AAG/T3, ALT/G23, T2/G23, and EFL/T3 of the present embodiment.

The distance from the object-side surface 811 of the first lens element 810 to the image plane 860 along the optical axis may be 3.028 mm and the image height of the optical imaging lens 8 may be 1.542 mm. Therefore, the length of the optical imaging lens 8 may be shortened compared with conventional optical imaging lenses. Thus, the optical imaging lens 8 may be capable to provide excellent imaging quality for smaller sized mobile devices.

FIG. 35(a) shows the longitudinal spherical aberration. From the vertical deviation of each curve shown in FIG. 35(a), the offset of the off-axis light relative to the image point may be within ±0.01 mm. Furthermore, the three curves having different wavelengths may be closed to each other, and this situation may represent that off-axis light with respect to these wavelengths is focused around an image point, and the aberration can be improved obviously.

FIGS. 35(b) and 35(c) respectively show the astigmatism aberration in the sagittal direction and astigmatism aberration in the tangential direction. Referring to FIG. 35(b), the focus variation with respect to the three different wavelengths (470 nm, 555 nm, 650 nm) in the whole field may fall within ±0.025 mm. Referring to FIG. 35(c), the focus variation with respect to the three different wavelengths (470 nm, 555 nm, 650 nm) in the whole field may fall within ±0.025 mm. Additionally, the three curves presenting different wavelengths may be closed to each other, and these closed curves may represent that the dispersion is improved. Please refer to FIG. 35(d), the variation of the distortion aberration of the optical imaging lens 8 may be within ±2.5%. Therefore, the optical imaging lens 8 of the present embodiment may exhibit great characteristics in the longitudinal spherical aberration, astigmatism in the sagittal direction, astigmatism in the tangential direction, and distortion aberration. According to above illustration, the optical imaging lens 8 of the example embodiment indeed achieves great optical performance and the length of the optical imaging lens 8 is effectively shortened.

Please refer to FIG. 38 for the values of T1/G12, ALT/G12, ALT, ALT/AAG, T4/G23, EFL/G23, ALT/T4, AAG/G23, T3/G12, T3/T4, T1/G23, G12/G23, AAG/T1, AAG/T3, ALT/G23, T2/G23, and EFL/T3 of all eight embodiments, and it is clear that the optical imaging lens of the present disclosure satisfy the Equations (1)˜(18).

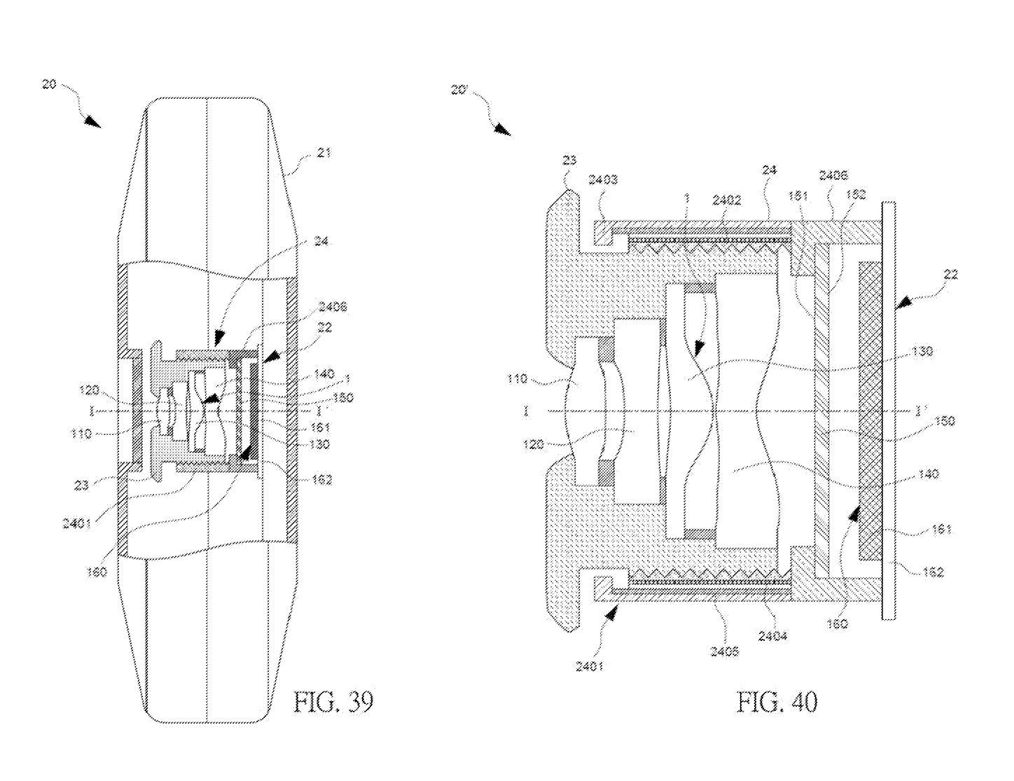

Reference is now made to FIG. 39, which illustrates an example structural view of a first embodiment of mobile device 20 applying an aforesaid optical imaging lens. The mobile device 20 may comprise a housing 21 and a photography module 22 positioned in the housing 21. Examples of the mobile device 20 may be, but are not limited to, a mobile phone, a camera, a tablet computer, a personal digital assistant (PDA), etc.

As shown in FIG. 39, the photography module 22 may have an optical imaging lens with fixed focal length, wherein the photography module 22 may comprise the aforesaid optical imaging lens with six lens elements. For example, photography module 22 may comprise the optical imaging lens 1 of the first embodiment, a lens barrel 23 for positioning the optical imaging lens 1, a module housing unit 24 for positioning the lens barrel 23, a substrate 162 for positioning the module housing unit 24, and an image sensor 161 which is positioned at an image side of the optical imaging lens 1. The image plane 160 may be formed on the image sensor 161.

In some other example embodiments, the structure of the filtering unit 150 may be omitted. In some example embodiments, the housing 21, the lens barrel 23, and/or the module housing unit 24 may be integrated into a single component or assembled by multiple components. In some example embodiments, the image sensor 161 used in the present embodiment may be directly attached to a substrate 162 in the form of a chip on board (COB) package, and such package may be different from traditional chip scale packages (CSP) since COB package does not require a cover glass before the image sensor 161 in the optical imaging lens 1. Aforementioned embodiments may not be limited to this package type and could be selectively incorporated in other described embodiments.

The four lens elements 110, 120, 130, 140 may be positioned in the lens barrel 23 in the way of separated by an air gap between any two adjacent lens elements.

The module housing unit 24 may comprise a lens backseat 2401 for positioning the lens barrel 23 and an image sensor base 2406 positioned between the lens backseat 2401 and the image sensor 161. The lens barrel 23 and the lens backseat 2401 may be positioned along a same axis I-I′, and the lens backseat 2401 is positioned at the inside of the lens barrel 23. The image sensor base 2406 may be exemplarily close to the lens backseat 2401 here. The image sensor base 2406 could be optionally omitted in some other embodiments of the present disclosure.

Because the length of the optical imaging lens 1 may be merely 2.945 mm, the size of the mobile device 20 may be quite small. Therefore, the embodiments described herein may advantageously meet the market demand for smaller sized product designs.

Reference is now made to FIG. 40, which shows another structural view of a second embodiment of mobile device 20′ applying the aforesaid optical imaging lens 1. One difference between the mobile device 20′ and the mobile device 20 may be the lens backseat 2401 comprising a first seat unit 2402, a second seat unit 2403, a coil 2404 and a magnetic unit 2405. The first seat unit 2402 is close to the outside of the lens barrel 23, and positioned along an axis I-I′, and the second seat unit 2403 is around the outside of the first seat unit 2402 and positioned along with the axis I-I′. The coil 2404 is positioned between the outside of the first seat unit 2402 and the inside of the second seat unit 2403. The magnetic unit 2405 is positioned between the outside of the coil 2404 and the inside of the second seat unit 2403.

The lens barrel 23 and the optical imaging lens 1 positioned therein may be driven by the first seat unit 2402 for moving along the axis I-I′. The rest structure of the mobile device 20′ may be similar to the mobile device 20.

Similarly, because the length of the optical imaging lens 1 may be 2.945 mm, is shortened, the mobile device 20′ may be designed with a smaller size and meanwhile good optical performance may still be provided. Therefore, the present embodiment meets the demand of small sized product design and the request of the market.

According to above illustration, it is clear that the mobile device and the optical imaging lens thereof in example embodiments, through controlling the detail structure of the lens elements and an inequality, the length of the optical imaging lens is effectively shortened and meanwhile good optical characteristics are still provided.

While various embodiments in accordance with the disclosed principles been described above, it should be understood that they are presented by way of example only, and are not limiting. Thus, the breadth and scope of exemplary embodiment(s) should not be limited by any of the above-described embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the disclosure set out in any claims that may issue from this disclosure. Specifically, a description of a technology in the “Background” is not to be construed as an admission that technology is prior art to this disclosure. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. An optical imaging lens, sequentially from an object side to an image side along an optical axis, comprising an aperture stop, first, second, third, and fourth lens elements, each of said first, second, third, and fourth lens elements having refracting power, an object-side surface facing toward the object side and an image-side surface facing toward the image side and a central thickness defined along an optical axis, wherein:
said image-side surface of said first lens element comprises a convex portion in a vicinity of a periphery of the first lens element;
said second lens element has negative refracting power, said object-side surface of said second lens element comprising a concave portion in a vicinity of the optical axis and a concave portion in a vicinity of a periphery of the second lens element;
said third lens element has positive refracting power, said object-side surface of said third lens element comprising a concave portion in a vicinity of the optical axis and a concave portion in a vicinity of a periphery of the third lens element, said image-side surface of said third lens element comprising a convex portion in a vicinity of the optical axis and a convex portion in a vicinity of a periphery of the third lens element;
said fourth lens element is made by plastic, said object-side surface of said fourth lens element comprising a convex portion in a vicinity of the optical axis, said image-side surface of said fourth lens element comprising a convex portion in a vicinity of a periphery of the fourth lens element; an air gap between the first lens element and the second lens element along the optical axis is represented by G12; a sum of a central thicknesses of all four lens elements along the optical axis is represented by ALT, and G12 and ALT satisfy three equations: T1/G12≦2.24, ALT/G12≦8.3, and ALT≦2.86 mm; and
wherein the optical imaging lens comprises no other lenses having refracting power beyond the first, second, third, and fourth lens elements.

2. The optical imaging lens according to claim 1, wherein a sum of all three air gaps from the first lens element to the four lens element along the optical axis is represented by AAG, ALT and AAG satisfy the equation: ALT/AAG≦4.5.

3. The optical imaging lens according to claim 2, wherein a central thickness of the fourth lens element is represented by T4, an air gap between the second lens element and the third lens element along the optical axis is represented by G23, and T4 and G23 satisfy the equation: T4/G23≦5.55.

4. The optical imaging lens according to claim 2, wherein an effective focal length of the optical imaging lens is represented by EFL, an air gap between the second lens element and the third lens element along the optical axis is represented by G23, and EFL and G23 satisfy the equation: EFL/G23≦30.

5. The optical imaging lens according to claim 1, wherein a central thickness of the fourth lens element is represented by T4, and T4 and ALT satisfy the equation: ALT/T4≦5.1.

6. The optical imaging lens according to claim 5, wherein a sum of all three air gaps from the first lens element to the four lens element along the optical axis is represented by AAG, an air gap between the second lens element and the third lens element along the optical axis is represented by G23, and AAG and G23 satisfy the equation: AAG/G23≦6.5.

7. The optical imaging lens according to claim 5, wherein a central thickness of the third lens element is represented by T3, and T3 and G12 satisfy the equation: 1.58≦T3/G12.

8. The optical imaging lens according to claim 1, wherein a central thickness of the third lens element is represented by T3, a central thickness of the fourth lens element is represented by T4, and T3 and T4 satisfy the equation: T3/T4≦2.

9. The optical imaging lens according to claim 8, wherein an air gap between the second lens element and the third lens element along the optical axis is represented by G23, and T1 and G23 satisfy the equation: T1/G23≦6.77.

10. The optical imaging lens according to claim 1, wherein an air gap between the second lens element and the third lens element along the optical axis is represented by G23, and G12 and G23 satisfy the equation: G12/G23≦5.0.

11. The optical imaging lens according to claim 10, wherein a sum of all three air gaps from the first lens element to the four lens element along the optical axis is represented by AAG, and AAG and T1 satisfy the equation: 0.9≦AAG/T1.

12. The optical imaging lens according to claim 1, wherein a sum of all three air gaps from the first lens element to the four lens element along the optical axis is represented by AAG, a central thickness of the third lens element is represented by T3, and AAG and T3 satisfy the equation: 0.7≦AAG/T3.

13. The optical imaging lens according to claim 12, wherein an air gap between the second lens element and the third lens element along the optical axis is represented by G23, and ALT and G23 satisfy the equation: ALT/G23≦23.85.

14. The optical imaging lens according to claim 1, wherein a central thickness of the second lens element is represented by T2, an air gap between the second lens element and the third lens element along the optical axis is represented by G23, and T2 and G23 satisfy the equation:
T2/G23≦4.0.

15. The optical imaging lens according to claim 14, wherein an effective focal length of the optical imaging lens is represented by EFL, a central thickness of the third lens element is represented by T3, and EFL and T3 satisfy the equation: 3.5≦EFL/T3.

16. The optical imaging lens according to claim 1, wherein a central thickness of the second lens element is represented by T2, an air gap between the second lens element and the third lens element along the optical axis is represented by G23, and T2 and G23 satisfy the equation: T2/G23≦2.5.

17. A mobile device, comprising:
a housing; and
a photography module positioned in the housing and comprising:
an optical imaging lens according to claim 1;
a lens barrel for positioning the optical imaging lens;
a module housing unit for positioning the lens barrel; and
an image sensor positioned at the image side of the optical imaging lens.
